(19) United States
(12) Patent Application Publication
(10) Pub. No.: US 2012/0069826 A1
(43) Pub. Date: Mar. 22, 2012

(54) TERMINAL DEVICE AND SIGNAL MULTIPLEXING CONTROL METHOD

(75) Inventors: Seigo Nakao, Kanagawa (JP); Daichi Imamura, Kanagawa (JP)

(73) Assignee: Panasonic Corporation, Osaka (JP)

(21) Appl. No.: 13/375,899

(22) PCT Filed: Jun. 8, 2010
(86) PCT No.: PCT/JP2010/003818

§ 371 Date: Dec. 2, 2011

(30) Foreign Application Priority Data
Jun. 9, 2009 (JP) 2009-138610

(51) Int. Cl. H04W 72/04

(52) U.S. Cl. 370/336

(57) ABSTRACT

Provided is a terminal device which achieves an improvement in the quality of uplink data while the power consumption of the terminal is suppressed even when the uplink data and a response signal are simultaneously transmitted in carrier aggregation. Specifically provided is a terminal device (200) which communicates with a base station device using a unit band group configured from N (N is a natural number of 2 or more) downlink unit bands and uplink unit bands, wherein when only uplink assignment control information is received in a first downlink unit band of the unit band group and only downlink assignment control information is received in a second downlink unit band different from the first downlink unit band when uplink data and a response signal are transmitted within the same transmission unit time, a control unit (208); time-multiplexes and transmits response signals with respect to the uplink data and downlink data transmitted through a downlink data channel indicated by the downlink assignment control information received in the second downlink unit band, through an uplink data channel indicated by the uplink assignment control information received in the first downlink unit band.

### TECHNICAL FIELD

The present invention relates to a terminal apparatus and signal multiplexing control method.

### BACKGROUND ART

3GPP LTE adopts OFDMA (Orthogonal Frequency Division Multiple Access) as a downlink communication scheme. In a radio communication system to which 3GPP LTE is applied, a base station transmits a synchronization signal (Synchronization Channel: SCH) and broadcast signal (Broadcast Channel: BCH) using predetermined communication resources. A terminal secures synchronization with the base station by catching an SCH first. After that, the terminal acquires parameters specific to the base station (e.g. frequency bandwidth) by reading BCH information (see Non-Patent Literatures 1, 2 and 3).

Furthermore, after completing the acquisition of parameters specific to the base station, the terminal issues a connection request to the base station to thereby establish communication with the base station. The base station transmits control information to the terminal with which communication is established via a PDCCH (Physical Downlink Control CHannel) as required.

The terminal then performs a “blind detection” on each of a plurality of pieces of control information included in the received PDCCH signal. That is, the control information includes a CRC (Cyclic Redundancy Check) portion and this CRC part is masked with a terminal ID of the transmission target terminal in the base station. Therefore, the terminal cannot decide whether or not the control information is directed to the terminal, until the CRC part of the received control information is demasked with the terminal ID of the terminal. When the demasking result shows that the CRC calculation is OK in the blind detection, the control information is decided to be directed to the terminal.

Furthermore, in 3GPP LTE, ARQ (Automatic Repeat reQuest) is applied to downlink data from a base station to a terminal. That is, the terminal feeds back a response signal indicating the error detection result of the downlink data to the base station. The terminal performs a CRC on the downlink data and feeds back ACK (Acknowledgment) when CRC=OK (no error) and NACK (Negative Acknowledgment) when CRC=NG (error present) as a response signal to the base station. An uplink control channel such as PUCCH (Physical Uplink Control Channel) is used for feedback of this response signal (that is, ACK/NACK signal). When the received response signal shows NACK, the base station transmits retransmission data to the terminal.

Here, the control information transmitted from the base station includes resource allocation information including resource information or the like allocated by the base station to the terminal. The aforementioned PDCCH is used to transmit this control information. This PDCCH is comprised of one or a plurality of L1/L2 CCHs (L1/L2 Control Channels). Each L1/L2 CCH is comprised of one or a plurality of CCEs (Control Channel Elements). That is, a CCE is a base unit when control information is mapped to a PDCCH. Furthermore, when one L1/L2 CCH is comprised of a plurality of CCEs, a plurality of continuous CCEs are allocated to the L1/L2 CCH. The base station allocates an L1/L2 CCH to the resource allocation target terminal according to the number of CCEs necessary to notify control information for the resource allocation target terminal. The base station then transmits control information mapped to physical resources corresponding to the CCEs of the L1/L2 CCH.

Here, each CCE has a one-to-one correspondence with PUCCH constituent resources. Therefore, the terminal that has received the L1/L2 CCH can implicitly identify the PUCCH constituent resources corresponding to CCEs making up the L1/L2 CCH, and transmits a response signal to the base station using the identified resources. This allows downlink communication resources to be used efficiently.

As shown in FIG. 1, a plurality of response signals transmitted from a plurality of terminals are spread by a ZAC (Zero Auto-Correlation) sequence having zero auto-correlation characteristic, Walsh code sequence and DFT (Discrete Fourier Transform) sequence on the time domain and code-multiplexed within the PUCCH. In FIG. 1, (W0, W1, W2, W3) represents a Walsh code sequence having a sequence length of 4 and (F0, F1, F2) represents a DFT sequence having a sequence length of 3. As shown in FIG. 1, in the terminal, a response signal such as ACK or NACK is primary-spread by a ZAC sequence (sequence length 12) on the frequency domain first. Next, the primary-spread response signal and the ZAC sequence as a reference signal are secondary-spread in association with a Walsh code sequence (sequence length 4: W0 to W3) and DFT sequence (sequence length 3: F0 to F3) respectively. The secondary-spread signal is further transformed into a signal having a sequence length of 12 on the time domain through IFFT (Inverse Fast Fourier Transform). A CP (Cyclic Prefix) is added to each signal after the IFFT and a one-slot signal comprised of seven SC-FDMA symbols is thereby formed.

Here, response signals transmitted from different terminals are spread using different amounts of cyclic shift (Cyclic shift Index) or different orthogonal code sequences (Orthogonal cover Index: OC Index) (that is, a set of Walsh code sequence and DFT sequence). Thus, the base station can separate the plurality of code multiplexed response signals using conventional despreading processing and correlation processing (see Non-Patent Literature 4).

Furthermore, standardization of 3GPP LTE-advanced has been started which realizes faster communication than 3GPP LTE. A 3GPP LTE-advanced system (hereinafter also referred to as “LTE-A system”) follows the 3GPP LTE system (hereinafter also referred to as “LTE system”). In order to realize a downlink transmission rate of a maximum of 1 Gbps or above, 3GPP LTE-advanced is expected to introduce base stations and terminals capable of communicating at a wideband frequency of 40 MHz or above.

In an LTE-A system, to realize communication at an ultra-high rate several times as fast as the transmission rate in an LTE system and backward compatibility with the LTE system simultaneously, a band for the LTE-A system is divided into “component bands” of 20 MHz or less, which is a support bandwidth of the LTE system. That is, the “component band” is a band having a width of maximum 20 MHz and defined as a base unit of a communication band. Furthermore, a “component band” in a downlink (hereinafter referred to as “downlink component band”) may be defined as a band divided by downlink frequency band information in a BCH broadcast from the base station or by a spreading width when the downlink control channel (PDCCH) is spread and arranged in the frequency domain. On the other hand, a “component band” in an uplink (hereinafter referred to as “uplink component band”) may be defined as a band divided by uplink frequency band information in a BCH broadcast from the base station or as a base unit of a communication baud of 20 MHz or less including a PUSCH (Physical Uplink Shared CHannel) region near the center and PUCCHs for LTE at both ends. Furthermore, in 3GPP LTE-Advanced, the “component baud” may also be expressed as “component carrier(s)” in English.

The LTE-A system supports communication using a band that bundles several component bands, so-called “carrier aggregation.” In the LTE-A system, studies are being carried out on carrier aggregation using the same number of component bands set for an arbitrary LTE-A system compatible terminal (hereinafter referred to as “LTE-A terminal”) between the uplink and downlink, so-called “symmetric carrier aggregation” and carrier aggregation using different number of component bands set for an arbitrary LTE-A terminal between the uplink and downlink, so-called “asymmetric carrier aggregation.” The latter is useful in a case where throughput requirements for the uplink are different from throughput requirements for the downlink. Furthermore, cases where the numbers of component bands are asymmetric between the uplink and downlink, and the frequency bandwidth differs from one component band to another are also expected to be supported.

By the way, in an LTE system and LTE-A system, the base station allocates resources to uplink data and downlink data independently of each other. Therefore, a situation may occur in the LTE system and LTE-A system in which an LTE terminal and LTE-A terminal must simultaneously transmit a response signal for downlink data and uplink data on an uplink. In this situation, the response signal and uplink data from the terminal are transmitted using time multiplexing (Time Division Multiplexing: TDM) or frequency multiplexing (Frequency Division Multiplexing: FDM). The LTE system adopts only TDM to maintain single carrier properties of a transmission waveform in a signal from the terminal.

In time multiplexing (TDM), a response signal transmitted from the terminal is transmitted to the base station by occupying some of resources (PUSCH resources) allocated for uplink data. That is, arbitrary data of uplink data is punctured by a response signal in PUSCH resources. Thus, arbitrary bits of the coded uplink data are punctured and quality (e.g. coding gain) of the uplink data thereby drastically deteriorates. Thus, the base station commands, for example, the terminal on a very low coding rate or very high transmission power, and thereby compensates for quality deterioration in the uplink data due to the puncturing.

On the other hand, in frequency multiplexing (FDM), a response signal transmitted from the terminal is transmitted to the base station using resources for a response signal (PUCCH resources) associated with CCEs occupied by L1/L2 CCH used to transmit downlink allocation control information indicating resources for downlink data and uplink data is allocated to PUSCH resources and transmitted to the base station. That is, the terminal allocates the response signal and uplink data to the PUSCH resources and PUCCH resources respectively and thereby frequency-multiplexes the response signal and uplink data. In the case of frequency multiplexing (FDM), although the single carrier properties of the signal transmitted from the terminal deteriorate, puncturing of uplink data by the response signal does not occur in the PUSCH resources, and it is thereby possible to maintain quality of the uplink data.

Furthermore, LTE-A is studying the following two modes as response signal transmission modes. That is, a first mode is a so-called non-bundling mode in which response signals are individually transmitted to a plurality of pieces of downlink data transmitted in a plurality of downlink component bands. In the so-called non-bundling mode, a plurality of response signals are simultaneously transmitted with different resources allocated to at least one of the frequency and code. The non-bundling mode may also be called “multi-code transmission mode.” On the other hand, a second mode is a so-called ACK/NACK bundling (hereinafter, simply referred to as “bundling”) in which a plurality of response signals corresponding to a plurality of pieces of downlink data transmitted in a plurality of downlink component bands are bundled together and transmitted. In bundling, the terminal calculates logical AND between a plurality of ACK/NACK signals to be transmitted and feeds back the calculation result to the base station as a “bundled ACK/NACK signal (or bundled response signal).”

When the above-described carrier aggregation is applied to the terminal, ARQ is controlled as follows. Here, for example, a case will be described where a component band group comprised of downlink component bands 1 and 2, and uplink component bands 1 and 2 is set for the terminal. That is, a case during symmetric carrier aggregation will be described where the number of downlink component bands and the number of uplink component bands making up a component band group set in a certain terminal are the same. In this case, downlink data is transmitted using resources indicated by the downlink allocation control information after downlink allocation control information is transmitted from the base station to the terminal using respective PDCCHs of downlink component bands 1 and 2.

Then, in the bundling mode, not only an ACK/NACK signal for downlink data transmitted in downlink component baud 1 but also an ACK/NACK signal for downlink data transmitted in downlink component band 2 is transmitted using a PUCCH of uplink component band 1 corresponding to downlink component band 1.

To be more specific, when the terminal succeeds in receiving both of the two pieces of downlink data (CRC=OK), the terminal calculates logical AND of ACK(=1) for downlink component band 1 and ACK(=1) for downlink component band 2 and transmits “1” (that is, ACK) as a result to the base station as a bundled ACK/NACK signal. Furthermore, when the terminal succeeds in receiving downlink data in downlink component band 1 and fails to receive downlink data in downlink component band 2, the terminal calculates logical AND of ACK(=1) for the downlink component band and NACK(=0) for downlink component band 2 and transmits “0” (that is, NACK) to the base station as a bundled ACK/NACK signal. Similarly, when the terminal fails to receive both of the two pieces of downlink data, the terminal calculates logical AND of NACK(=0) and NACK(=0) and transmits “0” (that is, NACK) to the base station as a bundled ACK/NACK signal.

Thus, in the bundling mode, the terminal transmits one ACK to the base station as a bundled ACK/NACK signal only when the terminal succeeds in receiving all of the plurality of pieces of downlink data transmitted to the terminal. On the contrary, when failing to receive even one piece of downlink data, the terminal transmits one NACK to the base station as a bundled ACK/NACK signal, and can thereby reduce overhead in the uplink control channel. The terminal side transmits a bundled ACK/NACK signal using PUCCH resources having the smallest frequency or identification number (Index) of the respective PUCCH resources corresponding to a plurality of CCEs occupied by the plurality of received downlink allocation control signals. However, if the terminal fails to receive even one piece of downlink data, the terminal returns NACK to the base station, and therefore the base station cannot help but retransmit all the data. That is, in the bundling mode, overhead in the uplink control channel can be reduced but the flexibility of retransmission control deteriorates.

On the other hand, in the non-bundling mode, ACK/NACK signals for downlink data transmitted in a plurality of downlink component bands are individually transmitted. Therefore, in the non-bundling mode, the base station needs only to retransmit downlink data that the terminal has failed to receive, and therefore the retransmission efficiency for downlink data can be improved. However, in the non-bundling mode, although the flexibility of retransmission control is high, an ACK/NACK signal is transmitted for each uplink component band, and therefore overhead in the uplink control channel increases compared to the bundling mode.

Therefore, the base station switches between the bundling mode and the non-bundling mode according to the situation of communication environment and controls a trade-off between the overhead reduction effect required for feedback and the effect of improving the downlink data retransmission efficiency.

### CITATION LIST

### Non-Patent Literature

### NPL 1

3GPP TS 36.211 V8.6.0, “Physical Channels and Modulation (Release 8),” March, 2009

### NPL 2

3GPP TS 36.212 V8.6.0, “Multiplexing and channel coding (Release 8),” March, 2009

### NPL 3

3GPP TS 36.213 V8.6.0, “Physical layer procedures (Release 8),” March, 2009

### NPL 4

Seigo Nakao, Tomofumi Takata, Daichi Imamura, and Katsuhiko Hiramatsu, “Performance enhancement of E-UTRA uplink control channel in fast fading environments,” Proceeding of IEEE VTC 2009 spring, April, 2009

### SUMMARY OF INVENTION

### Technical Problem

As described above, when the bundling mode is applied during carrier aggregation, the base station transmits downlink allocation control information using L1/L2 CCH included in PDCCH in each downlink component band and also transmits downlink data using PDSCH (Physical Downlink Shared Channel) as shown in FIG. 2. As shown in FIG. 2, the terminal then transmits a bundled ACK/NACK signal using one PUCCH resource of the plurality of PUCCH resources associated with CCEs occupied by each piece of downlink allocation control information (in FIG. 2, using a PUCCH resource included in PUCCH 1 of PUCCH 1 and PUCCH 2).

However, even when a plurality of pieces of downlink allocation control information are transmitted from the base station, the terminal does not always succeed in receiving all the downlink allocation control information. That is, PUCCH resources that should be used for the terminal to transmit a response signal change as shown, for example, in FIG. 3A to FIG. 3D depending on success/failure of reception of downlink allocation control information in the terminal. Here, a component band group comprised of downlink component bands 1 and 2, and uplink component bands 1 and 2 shown in FIG. 2 is set for the terminal. Furthermore, the base station transmits downlink allocation control information using PDCCH in downlink component bands 1 and 2 shown in FIG. 2. Furthermore, the base station commands the terminal to transmit a bundled ACK/NACK signal using uplink component band 1 beforehand.

FIG. 3A shows uplink component bands 1 and 2 when the terminal succeeds in receiving the downlink allocation control information of both downlink component bands 1 and 2 (hereinafter referred to as “normal case”). As shown in FIG. 3A, the terminal bundles a response signal for downlink data received through a downlink data channel (PDSCH) indicated by downlink allocation control information of each downlink component baud and transmits a bundled ACK/NACK signal in uplink component band 1.

FIG. 3B shows uplink component bands 1 and 2 in a case where the terminal succeeds in receiving downlink allocation control information of downlink component band 1 and fails to receive downlink allocation control information of downlink component band 2 (hereinafter referred to as “error case 1”). As shown in FIG. 3B, the terminal transmits a bundled ACK/NACK signal in uplink component band 1. The terminal recognizes failure of reception of downlink allocation control information transmitted in downlink component band 2 based on arrangement information (Downlink Assignment Indicator: DAI) of downlink allocation control information in each downlink component band included in the downlink allocation control information transmitted in downlink component band 1 shown in FIG. 2. Thus, in error case 1 shown in FIG. 3B, the terminal transmits NACK as a bundled ACK/NACK signal without depending on the error detection result with respect to the downlink data transmitted in downlink component band 1.

FIG. 3C shows uplink component bands 1 and 2 in a case where the terminal fails to receive downlink allocation control information of downlink component band 1 and succeeds in receiving downlink allocation control information of downlink component band 2 (hereinafter referred to as “error case 2”). As shown in FIG. 3C, the terminal transmits a bundled ACK/NACK signal in uplink component band 2. As in error case 1 (FIG. 3B), the terminal recognizes failure of reception of downlink allocation control information transmitted in downlink component band 1 based on a DAI included in downlink allocation control information transmitted in downlink component band 2 and transmits NACK as a bundled ACK/NACK signal.

FIG. 3D shows uplink component bands 1 and 2 in a case where the terminal fails to receive downlink allocation control information in all downlink component bands 1 and 2 (hereinafter referred to as “error case 3”). In this case, the terminal cannot recognize the presence of downlink data directed to the terminal, and as a result transmits no bundled ACK/NACK signal.

Furthermore, in FIG. 3A to FIG. 3D, the base station can decide whether or not the terminal has received control information transmitted in downlink component band 1 based on whether or not PUCCH resources (PUCCH 1) of uplink component band 1 are used (that is, a DTX detection on control information in downlink component band 1). For example, in FIG. 3A and FIG. 3B (that is, when the terminal succeeds in receiving control information (downlink allocation control information) of downlink component band 1), the terminal transmits a bundled ACK/NACK signal using PUCCH 1 of uplink component band 1. On the other hand, in FIG. 3C and FIG. 3D (that is, when the terminal fails to receive control information (downlink allocation control information) in downlink component band 1), the terminal does not use PUCCH 1 of uplink component band 1. Thus, the base station decides whether or not the terminal has normally received downlink allocation control information transmitted in uplink component band 1 according to whether or not PUCCH 1 of uplink component band 1 is used. This allows the base station to decide error case 2 shown in FIG. 3C (that is, that the terminal fails to receive downlink allocation control information transmitted from uplink component band 1).

Here, as described above, since the base station allocates resources to uplink data and downlink data independently of each other, as shown in FIG. 4, the terminal may simultaneously transmit a response signal for the downlink data and the uplink data in the same subframe (that is, within the same transmission unit time). In this case, the terminal may multiplex the uplink data and response signal using the aforementioned time multiplexing (TDM) or frequency multiplexing (FDM).

When time multiplexing (TDM) is used, as shown in FIG. 5A to FIG. 5C, in any case where a bundled ACK/NACK signal is transmitted, the terminal side punctures uplink data (UL data shown in FIG. 5A to FIG. 5C) using a bundled ACK/NACK signal, and therefore the quality of uplink data deteriorates. Furthermore, as shown in FIG. 5A to FIG. 5C, when transmitting uplink data and bundled ACK/NACK signal in the same subframe, the terminal transmits a bundled ACK/NACK signal using not PUCCH resources but PUSCH resources. For this reason, the base station cannot perform a DTX detection on the downlink allocation control information in downlink component band 1 shown in FIG. 4.

On the other hand, when using frequency multiplexing (FDM), in error case 2 shown in FIG. 6C, the terminal transmits uplink data (UL data shown in FIG. 6C) in uplink component band 1, whereas the terminal transmits a bundled ACK/NACK signal in uplink component band 2 (PUCCH 2). That is, in error case 2 shown in FIG. 6C, in order to transmit the uplink data and bundled ACK/NACK signal in the same subframe, the terminal must transmit the signal using two uplink component bands (e.g. 40 MHz), and therefore power consumption of the terminal increases.

Thus, when uplink data and a response signal are transmitted in the same subframe during carrier aggregation, the quality of uplink data deteriorates when time multiplexing (TDM) is used, while power consumption of the terminal increases when frequency multiplex (FDM) is used.

It is therefore an object of the present invention to provide a terminal apparatus and signal multiplexing control method capable of improving the quality of uplink data while reducing the power consumption of the terminal even when simultaneously transmitting uplink data and an ACK/NACK signal during carrier aggregation.

### Solution to Problem

A terminal apparatus according to the present invention is a terminal apparatus that communicates with a base station apparatus using a component band group comprised of N (where N is a natural number equal to 2 or above) downlink component bands and uplink component bands and transmits a response signal based on an error detection result of downlink data arranged in the downlink component band through an uplink control channel in the uplink component band corresponding to the downlink component band, and adopts a configuration to include a control information receiving section that receives uplink allocation control information and downlink allocation control information transmitted through downlink control channels of the N downlink component bands, a downlink data receiving section that receives the downlink data transmitted through the downlink data channel indicated by the downlink allocation control information, an uplink data transmission section that transmits uplink data through an uplink data channel indicated by the uplink allocation control information and a control section that controls transmission of the response signal based on the uplink allocation control information and the downlink allocation control information, wherein the control section receives, when transmitting uplink data and the response signal within the same transmission unit time, only the uplink allocation control information in a first downlink component band of the component band group and time-multiplexes, when receiving only the downlink allocation control information in a second downlink component band different from the first downlink component band, the uplink data and the response signal for the downlink data transmitted through the downlink data channel indicated by the downlink allocation control information received in the second downlink component band in the uplink data channel indicated by the uplink allocation control information received in the first downlink component band, and transmits the time-multiplexed signal.

A signal multiplexing control method of the present invention includes a control information receiving step of receiving uplink allocation control information and downlink allocation control information transmitted in downlink control channels of N (where N is a natural number equal to 2 or above) downlink component bands included in a component band group, a downlink data receiving step of receiving downlink data transmitted in a downlink data channel indicated by the downlink allocation control information, an uplink data transmitting step of transmitting uplink data through an uplink data channel indicated by the uplink allocation control information and a control step of controlling transmission of a response signal based on the uplink allocation control information and the downlink allocation control information, wherein, in the control step, when the uplink data and the response signal are transmitted in the same transmission unit time, if only the uplink allocation control information is received in a first downlink component band of the component band group and only the downlink allocation control information is received in a second downlink component band different from the first downlink component band, the uplink data and the response signal for the downlink data transmitted through the downlink data channel indicated by the downlink allocation control information received in the second downlink component band are time-multiplexed and transmitted in the uplink data channel indicated by the uplink allocation control information received in the first downlink component band.

### Advantageous Effects of Invention

According to the present invention, it is possible to provide a terminal apparatus and signal transmission control method capable of improving the quality of uplink data while reducing the power consumption of the terminal even when simultaneously transmitting uplink data and a response signal during carrier aggregation.

### BRIEF DESCRIPTION OF DRAWINGS

FIG. 1 is a diagram illustrating a method of spreading a response signal and reference signal;

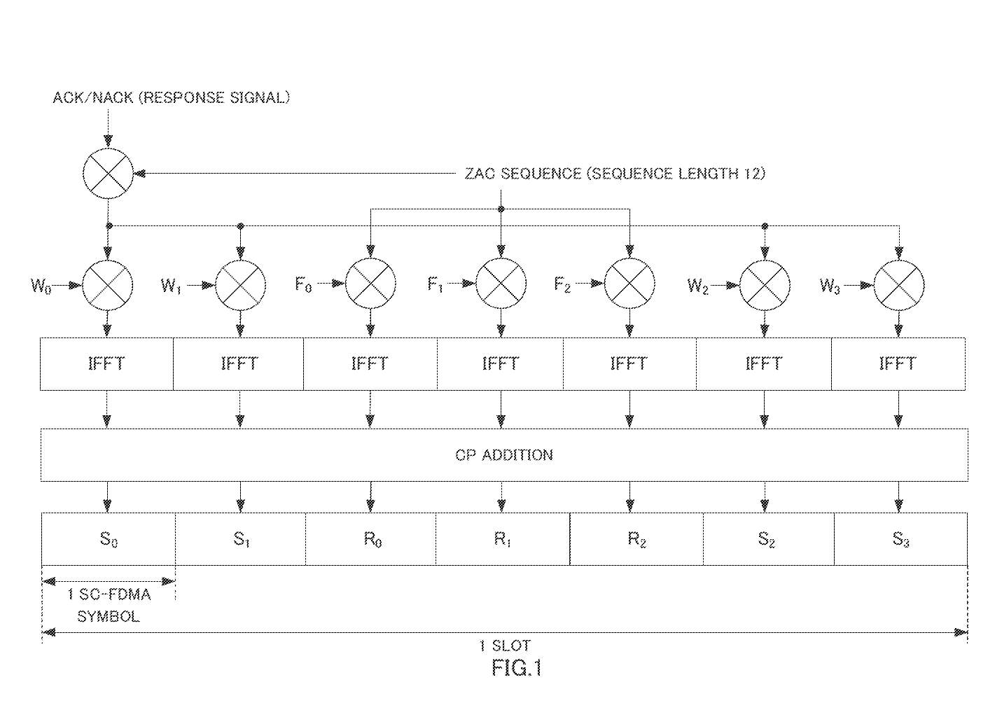

FIG. 2 is a diagram illustrating symmetric carrier aggregation applied to an individual terminal;

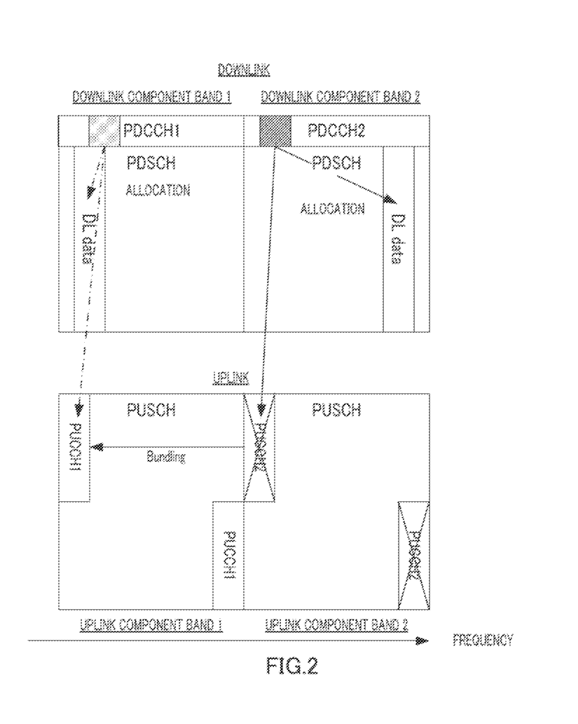

FIG. 3 is a diagram illustrating ARQ control processing when carrier aggregation is applied to a terminal;

FIG. 4 is a diagram illustrating symmetric carrier aggregation applied to an individual terminal;

FIG. 5 is a diagram illustrating ARQ control processing using time multiplexing;

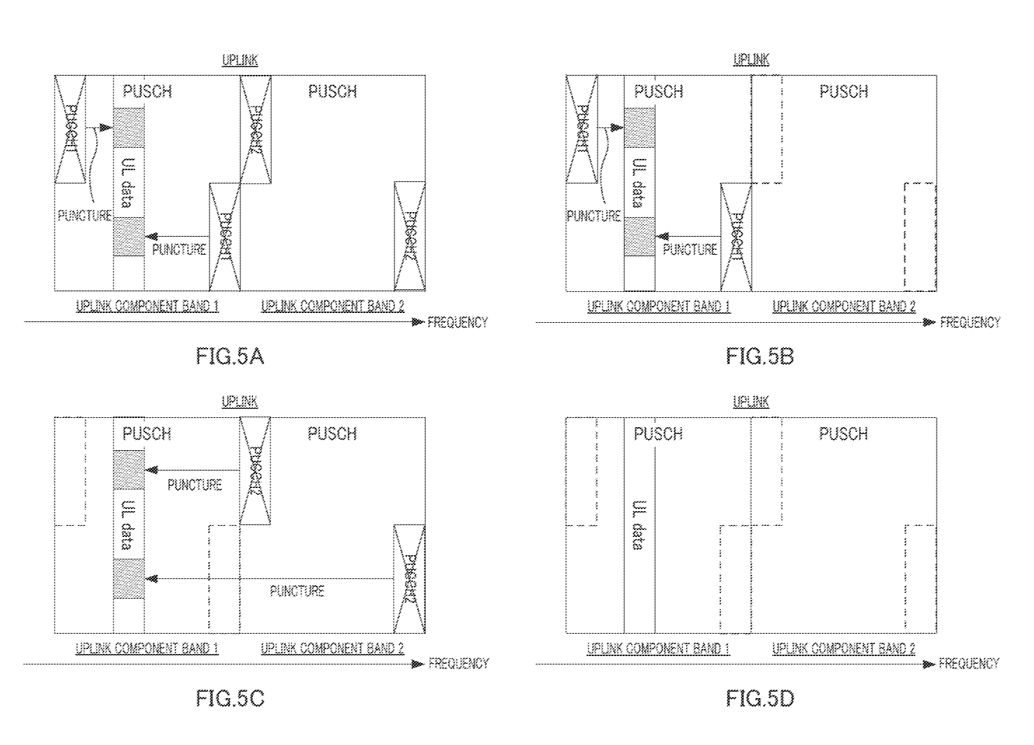

FIG. 6 is a diagram illustrating ARQ control processing using frequency multiplexing;

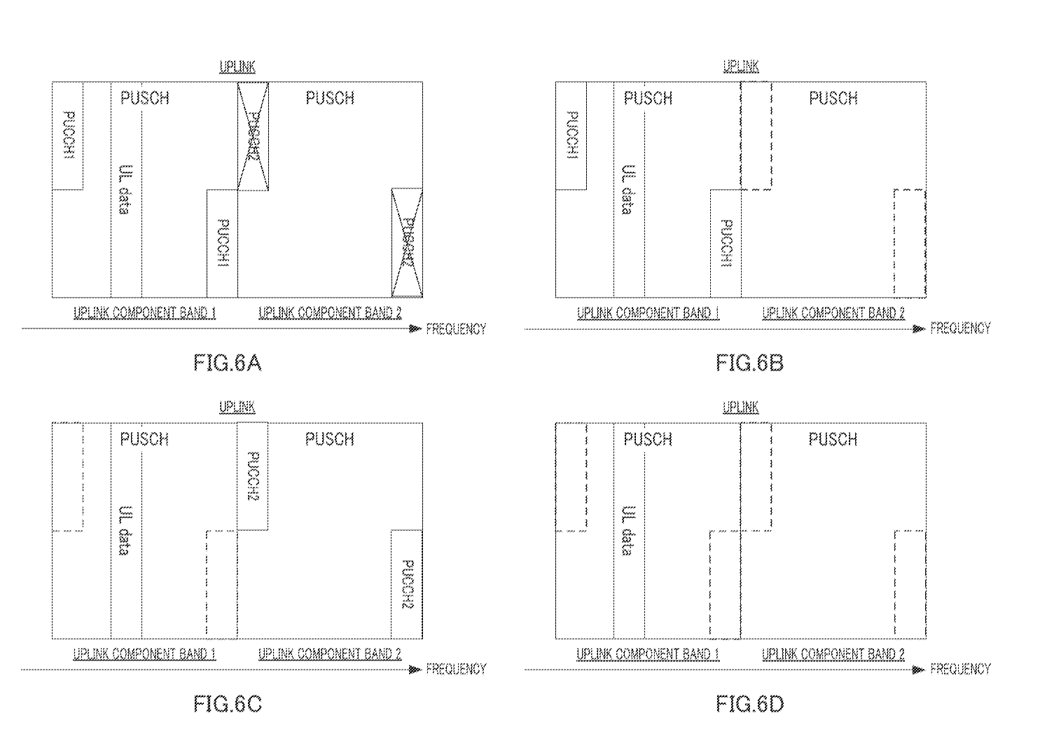

FIG. 7 is a block diagram showing a configuration of a base station according to Embodiment 1 of the present invention;

FIG. 8 is a block diagram showing a configuration of a terminal according to Embodiment 1 of the present invention;

FIG. 9 is a diagram illustrating operation of the terminal according to Embodiment 1 of the present invention;

FIG. 10 is a diagram illustrating symmetric carrier aggregation applied to another individual terminal according to Embodiment 1 of the present invention;

FIG. 11 is a diagram illustrating operation of the other terminal according to Embodiment 1 of the present invention;

FIG. 12 is a diagram illustrating symmetric carrier aggregation applied to an individual terminal according to Embodiment 2 of the present invention; and

FIG. 13 is a diagram illustrating operation of the terminal according to Embodiment 2 of the present invention.

### DESCRIPTION OF EMBODIMENTS

Hereinafter, embodiments of the present invention will be described in detail with reference to the accompanying drawings. The same components among different embodiments will be assigned the same reference numerals and overlapping descriptions thereof will be omitted.

### Embodiment 1

[Overview of Communication System]

A communication system including base station 100 and terminal 200, which will be described later, performs communication using N (where N is a natural number equal to 2 or above) uplink component bands and N downlink component bands associated with the N uplink component bands, that is, communication using symmetric carrier aggregation specific to terminal 200. The N uplink component bands and N downlink component bands constitute a “component band group” set for terminal 200. Furthermore, this communication system also includes a terminal that has no capacity for communication through carrier aggregation unlike terminal 200 and performs communication using one downlink component band and one uplink component band associated therewith (that is, communication not using carrier aggregation).

Therefore, base station 100 is configured to be able to support both communication using symmetric carrier aggregation and communication not using carrier aggregation.

Furthermore, communication not using carrier aggregation can also be performed between base station 100 and terminal 200 depending on resource allocation to terminal 200 by base station 100.

Furthermore, this communication system performs conventional ARQ when performing communication not using carrier aggregation, and on the other hand adopts bundling of a response signal in ARQ when performing communication using carrier aggregation. That is, this communication system is, for example, an LTE-A system, base station 100 is, for example, an LTE-A base station and terminal 200 is, for example, an LTE-A terminal. Furthermore, the terminal having no communication capability using carrier aggregation is, for example, an LTE terminal.

Descriptions will be given below assuming the following matters as premises. That is, symmetric carrier aggregation specific to terminal 200 is configured beforehand between base station 100 and terminal 200 and information of downlink component bands and uplink component bands to be used by terminal 200 is shared between base station 100 and terminal 200.

[Configuration of Base Station]

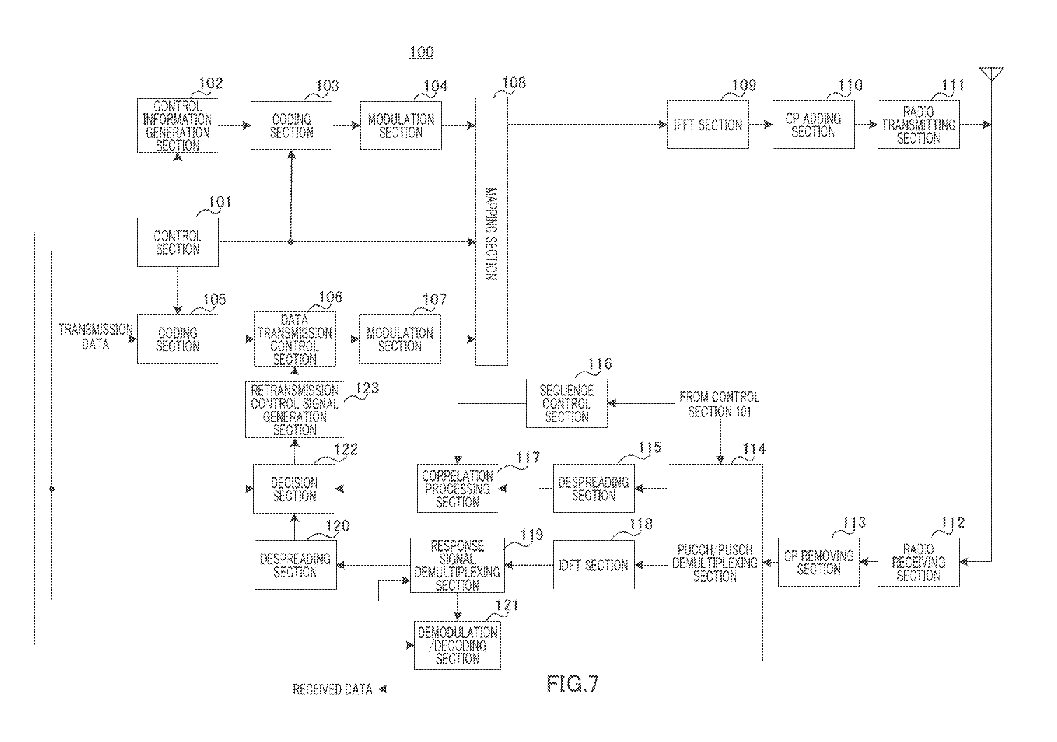

FIG. 7 is a block diagram illustrating a configuration of base station 100 according to the present embodiment. Base station 100 communicates with a terminal using a component band group comprised of N downlink component bands and uplink component bands.

In base station 100 shown in FIG. 7, control section 101 allocates (assigns), to resource allocation target terminal 200, downlink resources to transmit control information (that is, downlink control information allocation resources and uplink control information allocation resources), downlink resources to transmit downlink data included in the control information (that is, downlink data allocation resources) and uplink resources to transmit uplink data (that is, uplink data allocation resources). Such resources are allocated in downlink component bands and uplink component bands included in a component band group set (configured) in resource allocation target terminal 200. Furthermore, the downlink control information allocation resources and uplink control information allocation resources are selected from among resources corresponding to a downlink control channel (PDCCH) in each downlink component band. Furthermore, the downlink data allocation resources are selected from among resources corresponding to a downlink data channel (PDSCH) in each downlink component band and the uplink data allocation resources are selected from among resources corresponding to an uplink data channel (PUSCH) in each uplink component band. Furthermore, when there are a plurality of resource allocation target terminals 200, control section 101 allocates different resources to respective resource allocation target terminals 200.

The downlink control information allocation resources and uplink control information allocation resources are equivalent to above-described L1/L2 CCHs. That is, each of the downlink control information allocation resources and uplink control information allocation resources is comprised of one or a plurality of CCEs. Furthermore, each CCE included in the downlink control information allocation resources is associated with a constituent resource of an uplink control channel (PUCCH) on a one-by-one basis. However, CCEs are associated with PUCCH constituent resources in the association between downlink component bands and uplink component bands broadcast for an LTE system.

Furthermore, control section 101 determines a coding rate used to transmit control information to resource allocation target terminal 200. Since the amount of data of the control information differs according to this coding rate, control section 101 allocates downlink control information allocation resources and uplink control information allocation resources having a number of CCEs capable of mapping control information corresponding to this amount of data.

Control section 101 then outputs information on the downlink data allocation resources as well as uplink data allocation resources to control information generation section 102. Furthermore, control section 101 outputs information on a coding rate used to transmit control information to coding section 103. Furthermore, control section 101 determines a coding rate of transmission data (that is, downlink data), outputs the coding rate to coding section 105, determines a coding rate of received data (that is, uplink data) and outputs the coding rate to demodulation/decoding section 121. Furthermore, control section 101 outputs information on downlink data allocation resources, downlink control information allocation resources and uplink control information allocation resources to mapping section 108. Furthermore, control section 101 outputs information on uplink data allocation resources and information on PUCCH resources associated with CCEs occupied by the downlink control information allocation resources to PUCCH/PUSCH demultiplexing section 114 and sequence control section 116. Furthermore, control section 101 outputs information on a physical channel through which the terminal should transmit a response signal (that is, information indicating whether or not there is a possibility that a response signal from the terminal may be included in PUSCH or PUCCH) to response signal demultiplexing section 119 and decision section 122. However, control section 101 performs control so as to map downlink data and downlink allocation control information for notifying downlink data allocation resources to be used by the downlink data to the same downlink component band.

Control information generation section 102 generates control information for notifying downlink data allocation resources and control information for notifying uplink data allocation resources and outputs the control information to coding section 103. This control information is generated for each downlink component band and for each uplink component band. Furthermore, when there are a plurality of resource allocation target terminals 200, the control information includes a terminal ID of a destination terminal to distinguish between resource allocation target terminals 200. For example, the control information includes a CRC bit masked with a terminal ID of the destination terminal. This control information may be called “downlink allocation control information” and “uplink allocation control information.”

Coding section 103 encodes the control information inputted from control information generation section 102 according to the coding rate received from control section 101 and outputs the coded control information to modulation section 104.

Modulation section 104 modulates the coded control information and outputs the modulated signal obtained to mapping section 108.

Coding section 105 receives transmission data (that is, downlink data) for each transmission destination terminal 200 and coding rate information from control section 101 as input, encodes the transmission data at the coding rate indicated by coding rate information and outputs the transmission data to data transmission control section 106. However, when a plurality of downlink component bands are allocated to transmission destination terminal 200, coding section 105 encodes the transmission data transmitted in each downlink component band and outputs the coded transmission data to data transmission control section 106.

Data transmission control section 106 stores the coded transmission data upon initial transmission and outputs the coded transmission data to modulation section 107. The coded transmission data is stored for each transmission destination terminal 200. Furthermore, transmission data to one transmission destination terminal 200 is stored per downlink component band to be transmitted. This allows not only retransmission control over whole data transmitted to transmission destination terminal 200 but also retransmission control for each downlink component band.

Furthermore, when the retransmission control signal received from retransmission control signal generation section 123 indicates a retransmission command, data transmission control section 106 outputs the stored data corresponding to the retransmission control signal to modulation section 107. Furthermore, when the retransmission control signal received from retransmission control signal generation section 123 indicates that the data is not to be retransmitted, data transmission control section 106 deletes the stored data corresponding to the retransmission control signal. In this case, data transmission control section 106 outputs the next initial transmission data to modulation section 107. Since a bundled ACK/NACK signal relating to a plurality of pieces of transmission data is transmitted from terminal 200, upon receiving a retransmission control signal indicating a retransmission command, data transmission control section 106 outputs all of the plurality of pieces of stored data relating to the bundled ACK/NACK signal to modulation section 107.

Modulation section 107 modulates the coded transmission data received from data transmission control section 106 and outputs the modulated signal to mapping section 108.

Mapping section 108 maps the modulated signal (downlink allocation control information or uplink allocation control information) of the control information received from modulation section 104 to resources (resources within PDCCH) indicated by the downlink control information allocation resources and uplink control information allocation resources received from control section 101 and outputs the mapping result to IFFT section 109.

Furthermore, mapping section 108 maps the modulated signal (downlink data) of the transmission data received from modulation section 107 to resources (resources within PDSCH) indicated by the downlink data allocation resources received from control section 101 and outputs the mapping result to IFFT section 109.

The control information and transmission data (downlink data) mapped to a plurality of subcarriers in a plurality of downlink component bands by mapping section 108 are transformed by IFFT section 109 from a frequency domain signal to a time domain signal, transformed into an OFDM signal with a CP added by CP adding section 110, subjected to transmission processing such as D/A conversion, amplification and up-conversion in radio transmitting section 111 and transmitted to terminal 200 via an antenna. Thus, the uplink allocation control information and downlink allocation control information are transmitted through downlink control channels of the N downlink component bands and downlink data is transmitted through a downlink data channel indicated by the downlink allocation control information.

Radio receiving section 112 receives a signal including an uplink control channel signal (PUCCH signal) or uplink data channel signal (PUSCH signal) transmitted from terminal 200 via an antenna and performs reception processing such as down-conversion, A/D conversion on the received signal. The PUCCH signal includes only a response signal. Furthermore, the PUSCH signal includes uplink data. However, when terminal 200 time-multiplexes (TDM) a response signal and uplink data, the PUSCH signal includes both the uplink data and response signal.

CP removing section 113 removes a CP added to the received signal after the reception processing.

PUCCH/PUSCH demultiplexing section 114 demultiplexes the PUSCH signal from PUCCH signal included in the received signal on the frequency domain through FFT (Fast Fourier Transform) processing according to the command from control section 101. PUCCH/PUSCH demultiplexing section 114 then outputs the frequency component of the extracted PUCCH signal (signal including only a response signal) to despreading section 115 and outputs the frequency component of the extracted PUSCH signal (signal including only uplink data or signal including both the uplink data and response signal) to IDFT (Inverse Discrete Fourier Transform) section 118.

Despreading section 115 and correlation processing section 117 perform processing on the PUCCH signal extracted from the uplink component band used by terminal 200.

To be more specific, despreading section 115 despreads a signal (frequency domain signal) on the frequency domain corresponding to the PUCCH signal inputted from PUCCH/PUSCH demultiplexing section 114 using an orthogonal code sequence corresponding to the PUCCH resources for a response signal from terminal 200 and outputs the despread signal to correlation processing section 117.

Sequence control section 116 generates a ZAC sequence corresponding to the PUCCH resources for a response signal transmitted from terminal 200 according to the command from control section 101. Furthermore, sequence control section 116 identifies a correlation window including a response signal component from terminal 200 based on the ZAC sequence generated. Sequence control section 116 then outputs information indicating the identified correlation window and the generated ZAC sequence to correlation processing section 117.

Correlation processing section 117 finds a correlation value between the despread signal inputted from despreading section 115 and the ZAC sequence on the frequency domain using the information indicating the correlation window inputted from sequence control section 116 and the ZAC sequence and outputs the correlation value to decision section 122. That is, correlation processing section 117 extracts a signal component corresponding to the PUCCH resources for a response signal from terminal 200 included in the PUCCH signal and outputs the signal component to decision section 122.

IDFT section 118 applies IDFT processing to the frequency component of the PUSCH signal inputted from PUCCH/PUSCH demultiplexing section 114 and thereby transforms the PUSCH signal into a signal on the time domain.

Response signal demultiplexing section 119 demultiplexes the PUSCH signal on the time domain inputted from IDFT section 118 into a signal component that may contain a response signal and a signal component that contains uplink data on the time domain according to the command from control section 101. Response signal demultiplexing section 119 then outputs the signal component containing the response signal to despreading section 120 and outputs the signal component containing the uplink data to demodulation/decoding section 121.

Despreading section 120 despreads the signal component corresponding to the response signal inputted from response signal demultiplexing section 119 in a predetermined sequence and outputs the despread signal (that is, a correlation value between the signal component corresponding to the response signal and a predetermined sequence) to decision section 122.

Demodulation/decoding section 121 demodulates/decodes the signal component containing uplink data inputted from response signal demultiplexing section 119 using the coding rate corresponding to the uplink data inputted from control section 101 and outputs the signal component as received data.

Decision section 122 decides whether the response signal based on the error detection result of the downlink data is included in the uplink control channel (PUCCH resources) of the uplink component band corresponding to the downlink component band in which the downlink allocation control information is transmitted or the uplink data channel (PUSCH resources) indicated by the uplink allocation control information according to the command from control section 101.

To be more specific, decision section 122 decides whether or not a response signal is transmitted from terminal 200 using PUCCH resources based on the correlation value inputted from correlation processing section 117. That is, when the magnitude of the correlation value inputted from correlation processing section 117 is equal to or below a certain threshold, decision section 122 decides that terminal 200 is not transmitting any response signal using PUCCH resources. In this case, decision section 122 outputs information indicating “DTX for a response signal of the PUCCH resources” to retransmission control signal generation section 123. On the other hand, when the magnitude of the correlation value inputted from correlation processing section 117 is greater than the certain threshold, decision section 122 decides that terminal 200 is transmitting a response signal using PUCCH resources. In this case, decision section 122 further decides which of ACK or NACK is indicated by the response signal through, for example, coherent detection. Decision section 122 then outputs the decision result (ACK or NACK) to retransmission control signal generation section 123.

Furthermore, decision section 122 decides whether or not a response signal is transmitted from terminal 200 using PUSCH resources based on the despread signal inputted from despreading section 120. That is, when the magnitude of the despread signal inputted from despreading section 120 is equal to or below a certain threshold, decision section 122 decides that terminal 200 is not transmitting any response signal using PUSCH resources. In this case, decision section 122 outputs information indicating “DTX for the response signal of PUSCH resources” to retransmission control signal generation section 123. On the other hand, when the magnitude of the signal inputted from despreading section 120 is greater than the certain threshold, decision section 122 decides that terminal 200 is transmitting a response signal using PUSCH resources. In this case, decision section 122 decides which of ACK or NACK is indicated by the response signal through, for example, coherent detection. Decision section 122 then outputs the decision result (ACK or NACK) to retransmission control signal generation section 123.

Retransmission control signal generation section 123 decides whether or not to retransmit data transmitted in each downlink component band (downlink data) based on the information indicating the decision result (ACK or NACK) or DTX on the response signal inputted from decision section 122 and generates a retransmission control signal based on the decision result. To be more specific, when receiving a response signal indicating NACK or DTX, retransmission control signal generation section 123 generates a retransmission control signal indicating a retransmission command and outputs the retransmission control signal to data transmission control section 106. Furthermore, when receiving a response signal indicating ACK, retransmission control signal generation section 123 generates a retransmission control signal indicating that retransmission will not be performed and outputs the retransmission control signal to data transmission control section 106.

[Configuration of Terminal]

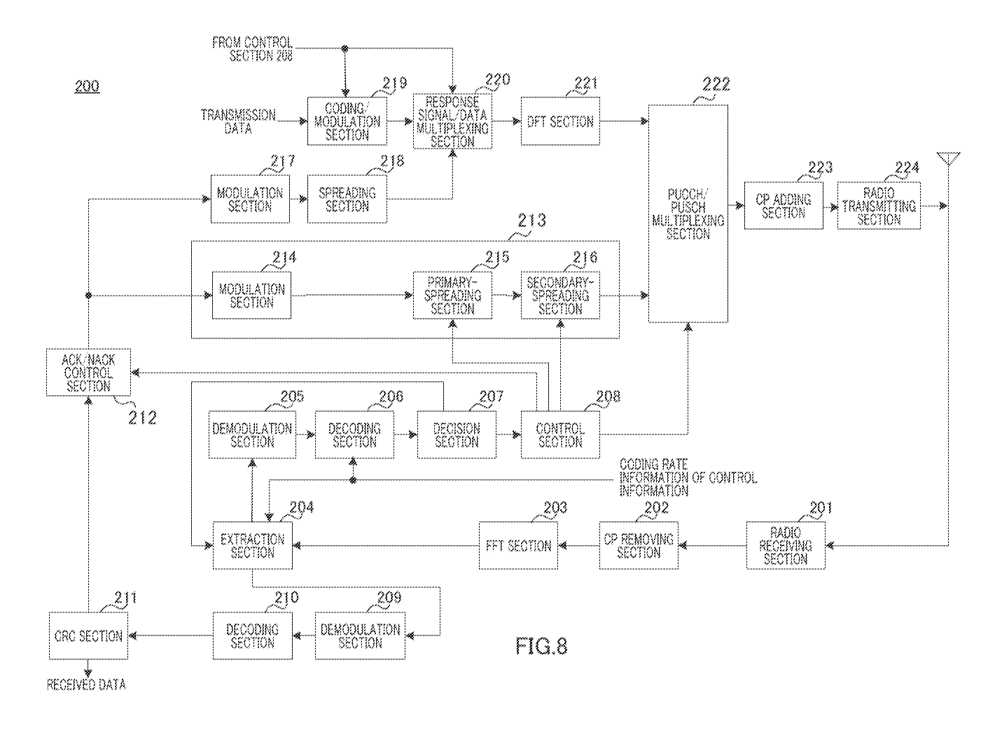

FIG. 8 is a block diagram illustrating a configuration of terminal 200 according to the present embodiment. Terminal 200 communicates with base station 100 using a component band group comprised of N downlink component bands and uplink component bands and transmits a response signal based on the error detection result of the downlink data arranged on the downlink component band using an uplink control channel of an uplink component band corresponding to the downlink component band.

In terminal 200 shown in FIG. 8, radio receiving section 201 receives an OFDM signal transmitted from base station 100 through an antenna and performs reception processing such as down-conversion, A/D conversion on the received OFDM signal. The received OFDM signal includes a PDSCH signal or PDCCH signal. That is, the uplink allocation control information and downlink allocation control information transmitted through downlink control channels of the N downlink component bands are received and downlink data transmitted through a downlink data channel indicated by the downlink allocation control information is received.

CP removing section 202 removes a CP added to the OFDM signal after the reception processing.

FFT section 203 applies FFT to the received OFDM signal, transforms the OFDM signal into a frequency domain signal and outputs the received signal obtained to extraction section 204.

Extraction section 204 extracts a downlink control channel signal (PDCCH signal) from the received signal received from FFT section 203 according to coding rate information inputted. That is, since the number of CCEs making up downlink control information allocation resources changes according to the coding rate, extraction section 204 extracts a downlink control channel signal using a number of CCEs corresponding to the coding rate as an extraction unit. Furthermore, the downlink control channel signal is extracted for each downlink component band. The extracted downlink control channel signal is outputted to demodulation section 205.

Furthermore, extraction section 204 extracts downlink data (downlink data channel signal (PDSCH signal)) from the received signal based on the information on the downlink data allocation resources directed to the terminal received from decision section 207 and outputs the downlink data to demodulation section 209.

Demodulation section 205 demodulates the downlink control channel signal received from extraction section 204 and outputs the demodulation result obtained to decoding section 206.

Decoding section 206 decodes the demodulation result received from demodulation section 205 according to the coding rate information inputted and outputs the decoding result obtained to decision section 207.

Decision section 207 performs a blind detection as to whether or not the control information included in the decoding result received from decoding section 206 is control information directed to the terminal. This decision is made based on the unit of the decoding result with respect to the above-described extraction unit. For example, decision section 207 demasks the CRC bit with the terminal ID of the terminal and decides that control information with CRC=OK (no error) is control information directed to the terminal. Decision section 207 then outputs information on the downlink data allocation resources for the terminal included in the downlink allocation control information directed to the terminal to extraction section 204. Furthermore, decision section 207 outputs the uplink allocation control information directed to the terminal to control section 208.

Furthermore, decision section 207 identifies the downlink component band to which the downlink allocation control information directed to the terminal is mapped and CCEs to which the downlink allocation control information directed to the terminal is mapped in the downlink component band and outputs the identification information of the identified downlink component band and CCE identification information to control section 208.

Control section 208 identifies the uplink component band that forms a pair with the downlink component band indicated by the identification information of the downlink component band received from decision section 207 and PUCCH resources (frequency/code) corresponding to the CCE indicated by the identification information of the CCE. Furthermore, control section 208 identifies PUSCH resources (uplink component band number and frequency position in the component band) used to transmit uplink data based on the information on the uplink data allocation resources with respect to the terminal included in the uplink allocation control information received from decision section 207. Control section 208 then outputs the identified PUSCH resources to PUCCH/PUSCH multiplexing section 222. Furthermore, control section 208 identifies the coding rate and modulation scheme of the uplink data based on the uplink allocation control information and outputs the identified coding rate and modulation scheme to coding/modulation section 219.

When the PUSCH resources used to transmit the uplink data and PUCCH resources used to transmit a response signal for the downlink data are present in the same uplink component band of the same subframe, control section 208 commands response signal/data multiplexing section 220 and PUCCH/PUSCH multiplexing section 222 to multiplex (FDM) the uplink data and response signal on the frequency domain. On the other hand, when the PUSCH resources used to transmit the uplink data and PUCCH resources used to transmit the response signal for the downlink data are not present in the same uplink component band of the same subframe, control section 208 commands response signal/data multiplexing section 220 and PUCCH/PUSCH multiplexing section 222 to multiplex (TDM) the uplink data and response signal in the PUSCH resources on the time domain without using the PUCCH resources.

Control section 208 then outputs the ZAC sequence and the amount of cyclic shift corresponding to the PUCCH resources in the uplink component band in which the PUCCH resources are used to primary-spreading section 215 of uplink control channel signal generation section 213 and outputs the frequency resource information to PUCCH/PUSCH multiplexing section 222. Furthermore, control section 208 outputs an orthogonal code sequence (that is, Walsh code sequence and DFT sequence) to be used for secondary-spreading corresponding to the PUCCH resources to secondary-spreading section 216 of uplink control channel signal generation section 213. Furthermore, control section 208 outputs the identification information of the downlink component band to which the control information directed to the terminal is mapped to ACK/NACK control section 212.

Demodulation section 209 demodulates the downlink data received from extraction section 204 and outputs the demodulated downlink data to decoding section 210.

Decoding section 210 decodes the downlink data received from demodulation section 209 and outputs the decoded downlink data to CRC section 211.

CRC section 211 generates the decoded downlink data received from decoding section 210, performs error detection for each downlink component band by CRC check and outputs ACK when CRC=OK (no error) and NACK when CRC=NG (error present) to ACK/NACK control section 212. Furthermore, when CRC=OK (no error), CRC section 211 outputs the decoded downlink data as the received data.

ACK/NACK control section 212 generates a response signal for the terminal to transmit to base station 100 based on a reception situation of downlink data transmitted in each downlink component band included in the component band group set in the terminal.

To be more specific, ACK/NACK control section 212 generates a bundled ACK/NACK signal as a response signal based on the identification information of the downlink component band inputted from control section 208 and success/failure of reception of downlink data. To be more specific, upon receiving all the downlink allocation control information corresponding to a plurality of pieces of downlink data transmitted by base station 100, ACK/NACK control section 212 calculates logical AND of response signals corresponding to the plurality of pieces of downlink data to generate a bundled ACK/NACK signal. Furthermore, when receiving none of the downlink allocation control information corresponding to the plurality of pieces of downlink data transmitted by base station 100, ACK/NACK control section 212 generates logical AND of the response signal corresponding to the downlink data received and NACK indicating failure of reception of the downlink allocation control information, that is, NACK as a bundled ACK/NACK signal. ACK/NACK control section 212 outputs this bundled ACK/NACK signal to modulation section 214 of uplink control channel signal generation section 213 and modulation section 217.

Uplink control channel signal generation section 213 generates an uplink control channel signal transmitted in the uplink component band using the response signal (bundled ACK/NACK signal) received from ACK/NACK control section 212. To be more specific, uplink control channel signal generation section 213 includes modulation section 214, primary-spreading section 215 and secondary-spreading section 216.

Modulation section 214 modulates the response signal (bundled ACK/NACK signal) inputted from ACK/NACK control section 212 and outputs the modulated signal to primary-spreading section 215.

Primary-spreading section 215 primary-spreads the response signal based on the ZAC sequence and the amount of cyclic shift set by control section 208 and outputs the primary-spread response signal to secondary-spreading section 216. That is, primary-spreading section 215 primary-spreads the response signal according to the command from control section 208.

Secondary-spreading section 216 secondary-spreads the response signal using the orthogonal code sequence set by control section 208 and outputs the secondary-spread response signal to PUCCH/PUSCH multiplexing section 222 as a waveform on the frequency domain (frequency domain signal). That is, secondary-spreading section 216 secondary-spreads the primary-spread response signal using the orthogonal code sequence corresponding to the resources selected by control section 208 and outputs the PUCCH component on the frequency domain (that is, PUCCH signal on the frequency domain) to PUCCH/PUSCH multiplexing section 222.

On the other hand, modulation section 217 modulates the response signal inputted from ACK/NACK control section 212 (bundled ACK/NACK signal) and outputs the modulated signal to spreading section 218.

Spreading section 218 spreads the modulated response signal inputted from modulation section 217 and outputs the spread response signal as a waveform on the time domain (time domain signal) to response signal/data multiplexing section 220.

Coding/modulation section 219 performs coding processing and modulation processing on transmission data (that is, uplink data) using the coding rate and modulation scheme commanded from control section 208 and outputs the modulated signal as a waveform on the time domain to response signal/data multiplexing section 220.

Response signal/data multiplexing section 220 determines whether or not to multiplex the uplink data inputted from coding/modulation section 219 and the response signal inputted from spreading section 218 on the time domain according to the command from control section 208. To be more specific, when commanded from control section 208 to multiplex the uplink data and response signal on the time domain, response signal/data multiplexing section 220 multiplexes the uplink data inputted from coding/modulation section 219 and the response signal inputted from spreading section 218 on the time domain and outputs the multiplexed signal to DFT section 221. On the other hand, when commanded from control section 208 not to multiplex the uplink data and response signal on the time domain, response signal/data multiplexing section 220 outputs only the uplink data inputted from coding/modulation section 219 to DFT section 221 (that is, the uplink data and response signal are not multiplexed on the time domain).

DFT section 221 transforms the signal on the time domain inputted from response signal/data multiplexing section 220 (that is, PUSCH signal on the time domain) into a signal on the frequency domain (that is, PUSCH signal on the frequency domain) through DFT processing and outputs the PUSCH signal on the frequency domain to PUCCH/PUSCH multiplexing section 222.

PUCCH/PUSCH multiplexing section 222 determines whether or not to multiplex the PUCCH signal inputted from secondary-spreading section 216 and the PUSCH signal inputted from DFT section 221 on the frequency domain. To be more specific, when commanded from control section 208 to multiplex the PUCCH signal and PUSCH signal on the frequency domain, PUCCH/PUSCH multiplexing section 222 applies IFFT processing to the PUCCH signal and PUSCH signal collectively (that is, multiplexes them on the frequency domain) and outputs the signal after the IFFT processing to CP adding section 223. On the other hand, when commanded from control section 208 not to multiplex the PUCCH signal and PUSCH signal on the frequency domain, PUCCH/PUSCH multiplexing section 222 applies IFFT processing to only the PUSCH signal (that is, without multiplexing the PUCCH signal and PUSCH signal on the frequency domain) and outputs the PUSCH signal after the IFFT processing (PUSCH signal on the time domain) to CP adding section 223.

When no command is received from control section 208, (that is, the PUCCH signal and PUSCH signal are not transmitted simultaneously in the same frame), PUCCH/PUSCH multiplexing section 222 arranges the PUCCH signal or PUSCH signal on the frequency domain based on resource information inputted from control section 208 and applies IFFT processing.

CP adding section 223 adds the same signal as that of the rear part of the signal on the time domain after the IFFT at the head of the signal as a CP.

Radio transmitting section 224 performs transmission processing such as D/A conversion, amplification and up-conversion on the signal received from CP adding section 223 and transmits the signal after the transmission processing from the antenna to base station 100. The uplink data is thereby transmitted through the uplink data channel indicated by the uplink allocation control information.

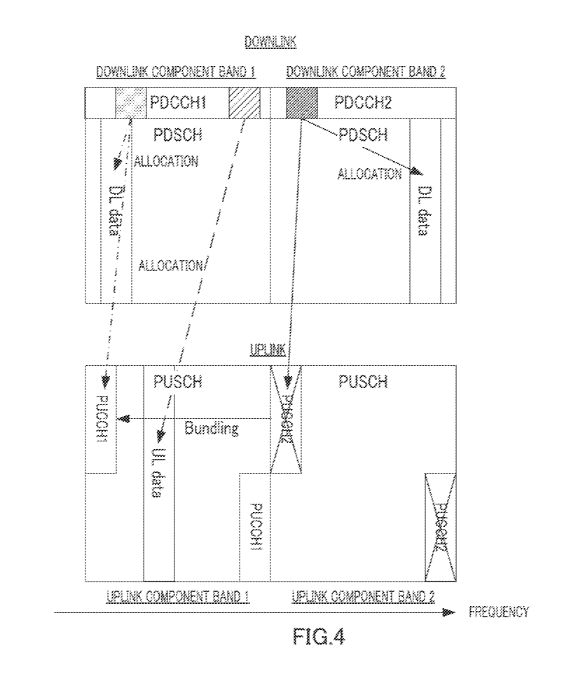

Next, operation of terminal 200 will be described. In the following descriptions, as shown in FIG. 4, a symmetric component band group comprised of two downlink component band; downlink component bands 1 and 2 and two uplink component bands; uplink component bands 1 and 2 is set in terminal 200. Base station 100 then transmits uplink allocation control information, downlink allocation control information and downlink data in downlink component bands 1 and 2. Here, terminal 200 normally receives the uplink allocation control information transmitted using resources in PDCCH 1 of the downlink component band shown in FIG. 4. That is, terminal 200 identifies the uplink data channel used to transmit the PUSCH signal including uplink data (UL data shown in FIG. 4) (PUSCH resources of uplink component baud 1 shown in FIG. 4). Furthermore, uplink component band 1 shown in FIG. 4 is set as the uplink component band to be used to transmit a bundled ACK/NACK signal when terminal 200 receives the downlink allocation control information using two downlink component bands 1 and 2 (that is, normal case). Furthermore, a plurality of CCEs making up PDCCH 1 of downlink component band 1 shown in FIG. 4 are associated with PUCCH 1 constituent resources of uplink component baud 1 respectively and a plurality of CCEs making up PDCCH 2 of downlink component band 2 shown in FIG. 4 are associated with PUCCH 2 constituent resources of uplink component band 2.

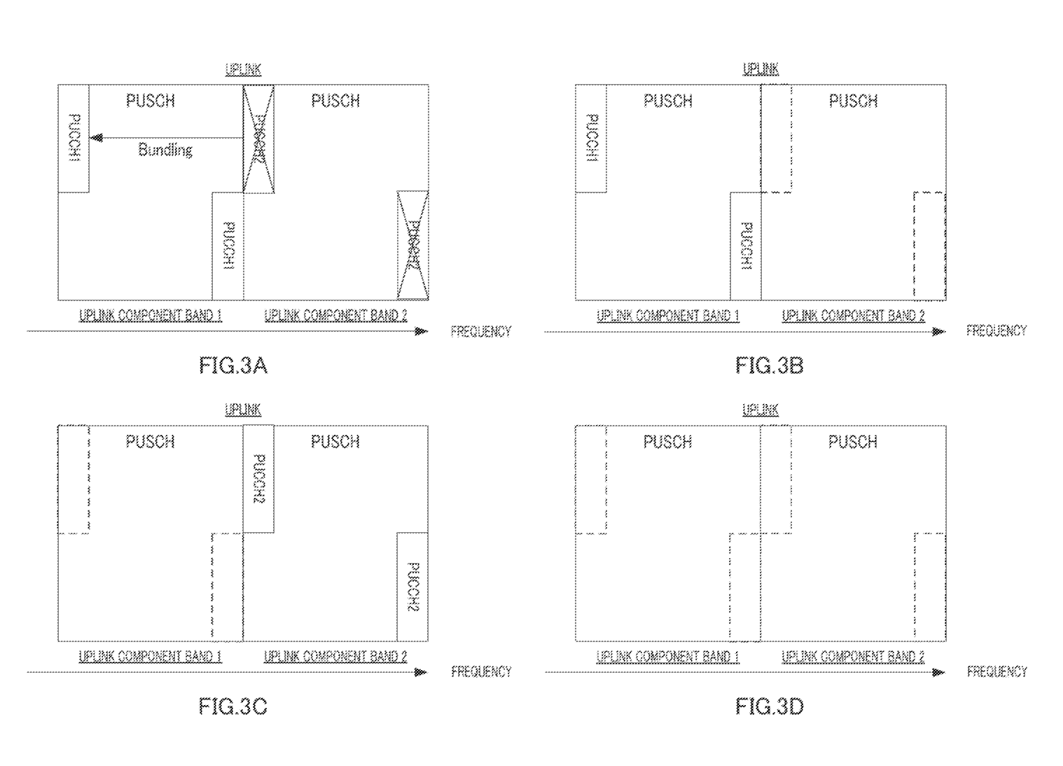

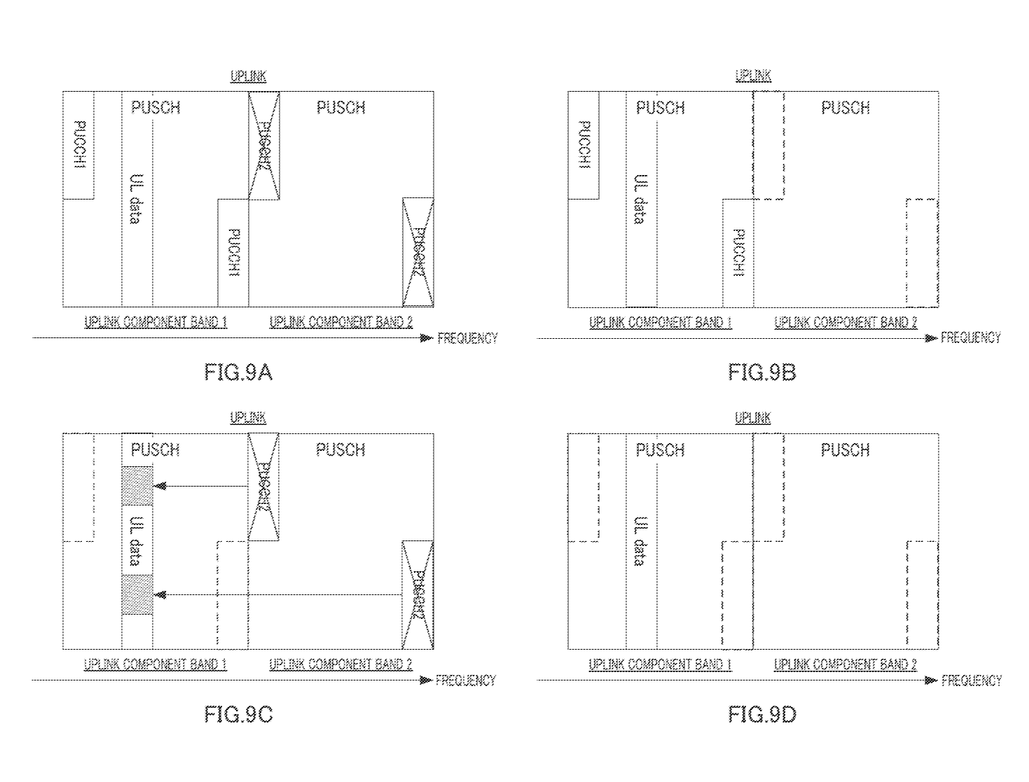

Hereinafter, detailed operation of the response signal multiplexing control processing by terminal 200 according to success/failure of reception of downlink allocation control information transmitted through PDCCH 1 of downlink component band 1 and PDCCH 2 of downlink component band 2 shown in FIG. 4 will be described using FIG. 9A to FIG. 9D illustrating the normal case and error cases 1 to 3 as in the cases of FIG. 3A to FIG. 3D.

In the following descriptions, as shown in FIG. 9A to FIG. 9D, control section 208 of terminal 200 identifies resources in PUSCH of uplink component band 1 as resources used to transmit uplink data based on the information on uplink data allocation resources for the terminal included in the uplink allocation control information normally received through PDCCH 1 of downlink component band 1 shown in FIG. 4.

<Normal Case (FIG. 9a): when Terminal 200 Receives Downlink Allocation Control Information Transmitted in Two Downlink Component Bands>

In terminal 200, ACK/NACK control section 212 generates a bundled ACK/NACK signal (logical AND of a response signal corresponding to the downlink data received in downlink component band 1 and a response signal corresponding to the downlink data received in downlink component band 2) based on the each error detection result (“ACK” or “NACK”) of the downlink data received in downlink component bands 1 and 2 inputted from CRC section 211.

Furthermore, control section 208 identifies uplink component bands 1 and 2 that form a pair with downlink component bands 1 and 2 to which downlink allocation control information directed to the terminal is mapped in the component band group shown in FIG. 4, and PUCCH resources corresponding to CCEs to which downlink allocation control information is mapped. Furthermore, in FIG. 9A, since the terminal receives downlink data in two downlink component bands 1 and 2, control section 208 identifies PUCCH 1 constituent resources in uplink component band 1 preset to transmit a bundled ACK/NACK signal out of the constituent resources of identified PUCCH 1 and PUCCH 2 as PUCCH resources to be used to transmit the bundled ACK/NACK signal.

That is, in FIG. 9A, terminal 200 identifies uplink component band 1 as an uplink component band to be used to transmit uplink data and identifies uplink component band 1 as an uplink component band to be used to transmit a bundled ACK/NACK signal based on the uplink allocation control information and downlink allocation control information first. That is, in FIG. 9A, when terminal 200 transmits the uplink data and bundled ACK/NACK signal in the same subframe, the uplink component band to be used to transmit uplink data is the same (uplink component band 1) as the uplink component band to be used to transmit a bundled ACK/NACK signal.

Thus, control section 208 multiplexes (FDM) the uplink data and bundled ACK/NACK signal on the frequency domain and performs control so as to transmit the multiplexed signal in the same subframe.

To be more specific, control section 208 commands response signal/data multiplexing section 220 not to time multiplex (TDM) the uplink data and bundled ACK/NACK signal. In this way, a PUSCH signal including only uplink data without including the bundled ACK/NACK signal is inputted to PUCCH/PUSCH multiplexing section 222.

Furthermore, control section 208 commands primary-spreading section 215 and secondary-spreading section 216 of uplink control channel signal generation section 213 on a ZAC sequence and orthogonal code sequence corresponding to the PUCCH resources (PUCCH 1 constituent resources) associated with CCEs occupied by the downlink allocation control information received in downlink component band 1.

Control section 208 then commands PUCCH/PUSCH multiplexing section 222 to frequency-multiplex (FDM) the PUCCH signal inputted from secondary-spreading section 216 (signal including the bundled ACK/NACK signal) and PUSCH signal inputted from DFT section 221 (signal including uplink data).

Thus, as shown in FIG. 9A, terminal 200 transmits a PUSCH signal including uplink data using PUSCH resources of uplink component band 1 and transmits a PUCCH signal including a bundled ACK/NACK signal using PUCCH resources (PUCCH 1 constituent resources) of uplink component band 1. That is, terminal 200 multiplexes (FDM) the uplink data and bundled ACK/NACK signal in PUCCH 1 of uplink component band 1 and PUSCH of uplink component band 1 on the frequency domain and transmits the multiplexed signal in the same sub frame.

Thus, terminal 200 can transmit the uplink data and bundled ACK/NACK signal in the same subframe using only one uplink component band (uplink component band 1 in FIG. 9A) without puncturing the uplink data.

<Error Case 1 (FIG. 9b): when Terminal 200 Receives Only Downlink Allocation Control Information Transmitted in Downlink Component Band 1>

In terminal 200, ACK/NACK control section 212 generates logical AND of an error detection result (“ACK” or “NACK”) for downlink data received in downlink component band 1 inputted from CRC section 211 and “NACK” indicating failure of reception of downlink allocation control information in downlink component band 2, that is, “NACK” as a bundled ACK/NACK signal.

Furthermore, control section 208 identifies uplink component band 1 that forms a pair with downlink component band 1 to which downlink allocation control information directed to the terminal is mapped in the component band group shown in FIG. 4 and PUCCH resources corresponding to CCEs to which downlink allocation control information is mapped. That is, control section 208 identifies the PUCCH 1 constituent resources of uplink component band 1 as PUCCH resources to be used to transmit a bundled ACK/NACK signal (“NACK”).

That is, in FIG. 9B as in the case of FIG. 9A (normal case), terminal 200 identifies uplink component band 1 as the uplink component band to be used to transmit uplink data and identifies uplink component band 1 as an uplink component band to be used to transmit a bundled ACK/NACK signal based on uplink allocation control information and downlink allocation control information first. That is, in FIG. 9B, when terminal 200 transmits the uplink data and bundled ACK/NACK signal in the same subframe, the uplink component band to be used to transmit uplink data is the same (uplink component band 1) as the uplink component band to be used to transmit a bundled ACK/NACK signal.

Thus, control section 208 performs control so as to multiplex (FDM) the uplink data and bundled ACK/NACK signal on the frequency domain and transmit the multiplexed signal in the same subframe as in the case of the normal case.

To be more specific, control section 208 performs processing similar to that in the normal case (FIG. 9A). That is, control section 208 commands response signal/data multiplexing section 220 not to time-multiplex (TDM) the uplink data and bundled ACK/NACK signal. Furthermore, control section 208 commands PUCCH/PUSCH multiplexing section 222 to frequency-multiplex (FDM) the PUCCH signal inputted from secondary-spreading section 216 (signal including a bundled ACK/NACK signal) and PUSCH signal inputted from DFT section 221 (signal including uplink data).

Furthermore, control section 208 commands primary-spreading section 215 and secondary-spreading section 216 of uplink control channel signal generation section 213 on a ZAC sequence and orthogonal code sequence corresponding to PUCCH resources (PUCCH 1 constituent resources) associated with CCEs occupied by downlink allocation control information received in downlink component band 1.

Thus, as shown in FIG. 9B, terminal 200 transmits a PUSCH signal including uplink data using PUSCH resources of uplink component band 1 and transmits a PUCCH signal including a bundled ACK/NACK signal using PUCCH resources (PUCCH 1) of uplink component band 1. That is, terminal 200 multiplexes (FDM) the uplink data and bundled ACK/NACK signal on PUCCH 1 of uplink component band 1 and PUSCH of the uplink component band on the frequency domain and transmits the multiplexed signal in the same subframe.

Thus, terminal 200 can transmit the uplink data and bundled ACK/NACK signal in the same subframe using only one uplink component band (uplink component band 1 in FIG. 9B) without puncturing the uplink data.

The operation of terminal 200 shown in FIG. 9B is applicable not only to error case 1 (when failing to receive downlink allocation control information of downlink component band 2 in FIG. 9B) but also to a case where base station 100 transmits downlink allocation control information to terminal 200 using only downlink component band 1. That is, terminal 200 determines the method of multiplexing (TDM or FDM) the uplink data and ACK/NACK signal according to the number of pieces of downlink allocation control information that the terminal has actually received and the position of the downlink component baud to which the received downlink allocation control information is mapped irrespective of the number of downlink component bands in which base station 100 has actually transmitted downlink allocation control information.

<Error Case 2 (FIG. 9c): when Terminal 200 Receives Only Downlink Allocation Control Information Transmitted in Downlink Component Band 2>

In terminal 200, ACK/NACK control section 212 generates logical AND of an error detection result (“ACK” or “NACK”) with respect to the downlink data inputted from CRC section 211 and received in downlink component band 2 and “NACK” indicating failure of reception of downlink allocation control information in downlink component band 1, that is, “NACK” as a bundled ACK/NACK signal.

Furthermore, control section 208 identifies uplink component band 2 that forms a pair with downlink component band 2 to which downlink allocation control information directed to the terminal is mapped in the component band group shown in FIG. 4 and PUCCH resources corresponding to CCEs to which downlink allocation control information is mapped. That is, control section 208 identifies PUCCH 2 constituent resources of uplink component band 2 as PUCCH resources to be used to transmit a bundled ACK/NACK signal (“NACK”).

That is, in FIG. 9C, terminal 200 identifies uplink component band 1 as the uplink component band to be used to transmit uplink data and identifies uplink component band 2 as the uplink component baud to be used to transmit a bundled ACK/NACK signal based on uplink allocation control information and downlink allocation control information first. That is, in FIG. 9C, when terminal 200 transmits the uplink data and bundled ACK/NACK signal in the same subframe, the uplink component band (uplink component band 1) to be used to transmit uplink data is different from the uplink component band (uplink component band 2) to be used to transmit the bundled ACK/NACK signal.

Thus, control section 208 performs control so as to multiplex (TDM) the uplink data and bundled ACK/NACK signal in PUSCH resources of the uplink component band to be used to transmit the uplink data on the time domain and transmit the multiplexed signal.

To be more specific, control section 208 commands response signal/data multiplexing section 220 to time-multiplex (TDM) the uplink data and bundled ACK/NACK signal. Therefore, response signal/data multiplexing section 220 punctures uplink data according to the bundled ACK/NACK signal and thereby time-multiplexes the uplink data and bundled ACK/NACK signal. This causes a PUSCH signal including the uplink data and bundled ACK/NACK signal to be inputted to PUCCH/PUSCH multiplexing section 222.

Furthermore, control section 208 commands PUCCH/PUSCH multiplexing section 222 to perform IFFT processing on only the PUSCH signal (signal including uplink data and bundled ACK/NACK signal) inputted from DFT section 221. In other words, control section 208 commands PUCCH/PUSCH multiplexing section 222 not to frequency-multiplex (FDM) the PUSCH signal inputted from DFT section 221 and PUCCH signal inputted from secondary-spreading section 216.

Thus, as shown in FIG. 9C, terminal 200 transmits a PUSCH signal including the uplink data and bundled ACK/NACK signal using PUSCH resources of uplink component band 1. That is, terminal 200 multiplexes (TDM) the uplink data and bundled ACK/NACK signal in PUSCH of uplink component band on the time domain without using PUCCH 2 of uplink component band 2 and transmits the multiplexed signal in the same subframe.

Thus, terminal 200 can transmit the uplink data and bundled ACK/NACK signal in the same subframe using only one uplink component band (uplink component band 1 in FIG. 9C).

Here, in FIG. 9C, the uplink data mapped to PUSCH resources in uplink component band 1 is punctured by the bundled ACK/NACK signal, and therefore the quality of uplink data deteriorates. However, an LTE-A system is operated with an error rate of downlink allocation control information (that is, Target Block error rate (Target BLER) of PDCCH signal) of on the order of 1%, and therefore the situation in which error case 2 (FIG. 9C) occurs is extremely rare (frequency of the occurrence of error case 2: on the order of 1%). Therefore, only in error case 2 as shown in FIG. 9C, even when terminal 200 time-multiplexes the uplink data and bundled ACK/NACK signal (that is, even when uplink data is punctured), the influence on the entire system is extremely small.

The operation of terminal 200 shown in FIG. 9C is applicable not only to error case 2 (when failing to receive downlink allocation control information of downlink component band 1 in FIG. 9C) but also to a case where base station 100 transmits downlink allocation control information to terminal 200 in only downlink component band 2. For example, this is a case where base station 100 allocates downlink data (that is, downlink allocation control information) to only downlink component band 2 and allocates uplink data (that is, uplink allocation control information) to only uplink component band 1. However, in this case, even when terminal 200 normally receives all allocation information (uplink allocation control information transmitted in downlink component band 1 and downlink allocation control information transmitted in downlink component band 2) (that is, normal case), the uplink data transmitted in the uplink component band is punctured by response signal for the downlink data transmitted in downlink component band 2 as shown in FIG. 9C. Therefore, base station 100 generally does not perform such an operation as to allocate downlink data to only one downlink component band (downlink component band 2 in FIG. 9C) for terminal 200 and at the same time allocate uplink data to only the other uplink component band (uplink component band 1 in FIG. 9C).

<Error Case 3 (FIG. 9d): when Terminal 200 Receives None of Downlink Allocation Control Information Transmitted in Downlink Component Bands 1 and 2>

In error case 3 shown in FIG. 9D, since terminal 200 does not know the presence of downlink allocation control information transmitted by base station 100 in downlink component bands 1 and 2 and cannot receive downlink data, there is no ACK/NACK signal to transmit. Therefore, terminal 200 identifies uplink component band 1 as the uplink component band to be used to transmit the uplink data based on the uplink allocation control information as shown in FIG. 9D.

Thus, control section 208 commands response signal/data multiplexing section 220 not to time-multiplex (TDM) the uplink data and response signal. Furthermore, control section 208 commands PUCCH/PUSCH multiplexing section 222 to perform IFFT processing on only the PUSCH signal (signal including an uplink data signal) inputted from DFT section 221.

Thus, as shown in FIG. 9D, terminal 200 transmits a PUSCH signal including uplink data using PUSCH resources of uplink component band 1.

The operation of terminal 200 according to success/failure of reception of a PDCCH signal including downlink allocation control information has been described so far.

On the other hand, decision section 122 of base station 100 decides whether or not a response signal (bundled ACK/NACK signal) is included in PUCCH resources of uplink component bands 1 and 2 in the component band group set in terminal 200 based on a correlation value inputted from correlation processing section 117. Furthermore, decision section 122 decides whether or not a response signal (bundled ACK/NACK signal) is included in PUSCH resources of uplink component bands 1 and 2 in the component band group set in terminal 200 based on the despread signal inputted from despreading section 120.

That is, in FIG. 4, decision section 122 decides whether or not a response signal (bundled ACK/NACK signal) with respect to the downlink data transmitted using PDSCH resources indicated by each piece of downlink allocation control information of downlink component bands 1 and 2 is included in PUCCH resources (PUCCH 1 constituent resources and 2) of uplink component bands 1 and 2 corresponding to downlink component bands 1 and 2 used to transmit downlink allocation control information or PUSCH resources indicated by uplink allocation control information of downlink component band 1.

For example, in FIG. 9A and FIG. 9B, decision section 122 of base station 100 decides that a bundled ACK/NACK signal is included in PUCCH resources making up PUCCH 1 of uplink component baud 1 provided with PUSCH resources indicated by uplink allocation control information transmitted in downlink component band 1. On the other hand, in FIG. 9C, decision section 122 of base station 100 decides that a bundled ACK/NACK signal is included in PUSCH resources indicated by uplink allocation control information transmitted in downlink component band 1. That is, when decision section 122 of base station 100 receives the uplink data and response signal (bundled ACK/NACK signal) in the same subframe, both the uplink data and response signal are received, in the same uplink component band (uplink component band 1 in FIG. 9A to FIG. 9C).

Thus, when the uplink component band provided with an uplink data channel (PUSCH) indicated by uplink allocation control information (that is, uplink component band used to transmit uplink data) is different from the uplink component band provided with PUCCH resources associated with CCEs occupied by downlink allocation control information (that is, uplink component band used to transmit a response signal with respect to downlink data), terminal 200 time-multiplexes the uplink data and response signal through an uplink data channel (PUSCH) used to transmit uplink data and transmits the multiplexed data.

In other words, when the downlink component band provided with the downlink control channel through which uplink allocation control information is transmitted (PDCCH 1 shown in FIG. 4 in error case 2 (FIG. 9C)) is different from the downlink component band provided with a downlink control channel through which downlink allocation control information is transmitted (PDCCH 2 shown in FIG. 4 in error case 2 (FIG. 9C)), terminal 200 time-multiplexes the uplink data and response signal through an uplink data channel used to transmit uplink data (PUSCH in uplink component band 1 in error case 2 (FIG. 9C)) and transmits the multiplexed data. That is, in a subframe in which the uplink data and response signal are simultaneously transmitted, terminal 200 time-multiplex the response signal for downlink data received in the downlink component band to which the uplink allocation control information is not mapped (that is, a downlink component band that forms a pair with the uplink component band to which no uplink data is allocated or downlink component band to which only downlink allocation control information is mapped) and uplink data in the uplink data channel indicated by uplink allocation control information received in the other downlink component band and transmits the multiplexed signal.

That is, when terminal 200 transmits the uplink data and response signal in the same subframe, if terminal 200 receives only uplink allocation control information in a first downlink component band (e.g. downlink component band 1 shown in FIG. 4) of the component band group set in the terminal and receives only downlink allocation control information in a second downlink component band (e.g. downlink component band 2 shown in FIG. 4) different from the first downlink component band, terminal 200 time-multiplexes the uplink data and a response signal for the downlink data transmitted through the downlink data channel indicated by the downlink allocation control information received in the second downlink component band (downlink component band 2 shown in FIG. 4), in the uplink data channel (PUSCH in uplink component band 1 shown in FIG. 4) indicated by the uplink allocation control information received in the first downlink component band, and transmits the multiplexed signal.

On the other hand, when the uplink component band provided with an uplink data channel (PUSCH) indicated by uplink allocation control information (that is, uplink component band used to transmit uplink data) is the same as the uplink component band provided with PUCCH resources associated with CCEs occupied by downlink allocation control information (that is, uplink component band used to transmit a response signal for downlink data), terminal 200 frequency-multiplexes the uplink data and response signal using the uplink data channel (PUSCH) and uplink control channel (PUCCH) and transmits the multiplexed signal.

In other words, when the downlink component band provided with the downlink control channel (PDCCH 1 shown in FIG. 4 in normal case (FIG. 9A) and error case 1 (FIG. 9B)) through which uplink allocation control information is transmitted is the same as the downlink component band provided with the downlink control channel (PDCCH 1 shown in FIG. 4 in normal case (FIG. 9A) and error case 2 (FIG. 9B)) through which downlink allocation control information is transmitted, terminal 200 frequency-multiplexes the uplink data and response signal using the uplink data channel (PUSCH) and uplink control channel (PUCCH) and transmits the multiplexed signal.

Thus, when transmitting uplink data and bundled ACK/NACK signal in the same subframe (within the same transmission unit time), terminal 200 determines whether to time-multiplex or frequency-multiplex the uplink data and bundled ACK/NACK signal depending on whether the uplink component band to transmit the bundled ACK/NACK signal is the same as the uplink component band to transmit the uplink data.

Here, when time-multiplexing (TDM) is used, uplink data is punctured by a response signal as shown in FIG. 9C, and therefore the quality of uplink data deteriorates. On the other hand, when frequency multiplexing (FDM) is used as the method of multiplexing uplink data and response signal, the single carrier properties of the transmission waveform of a signal from the terminal deteriorates (or CM (Cubic Metric) characteristic deteriorates). However, as shown in FIG. 9A to FIG. 9D, communication through carrier aggregation is likely to be set in a terminal at the center of the cell (cell center UE) showing good channel quality. For this reason, in terminal 200 (cell center UE) carrying out communication through carrier aggregation, even when the uplink data and response signal are frequency-multiplexed (FDM) and transmitted, the influence that a transmission signal of terminal 200 receives from the deterioration in the single carrier properties is extremely small. Therefore, when multiplexing and transmitting uplink data and response signal, terminal 200 preferably reduces the use of time-multiplexing (TDM) (that is, frequency with which uplink data is punctured) to a minimum and uses frequency multiplexing (FDM).

As shown in FIG. 9A to FIG. 9D, the present embodiment uses time-multiplexing (TDM) for only error case 2 (FIG. 9C) and terminal 200 uses frequency multiplexing (FDM) in cases other than error case 2 (FIGS. 9A and B). Furthermore, the probability that error case 2 shown in FIG. 9C occurs (Target BLER of PDCCH signal) is on the order of 1% as described above. Therefore, terminal 200 can reduce the use of time-multiplexing (TDM) (that is, frequency with which uplink data is punctured by a bundled ACK/NACK signal) to a minimum. Therefore, terminal 200 can substantially suppress quality deterioration of the uplink data.

Furthermore, as shown in FIG. 9A to FIG. 9C, when transmitting uplink data and response signal in the same subframe, terminal 200 always uses only one uplink component band (uplink component band 1 in FIG. 9A to FIG. 9C). That is, even when transmitting uplink data and response signal in the same subframe, terminal 200 can suppress the band used for the uplink to only a minimum necessary uplink component band for transmission of uplink data (PUSCH signal). This allows terminal 200 to suppress power consumption upon transmission of the uplink data and response signal.

Furthermore, as shown in FIG. 9A to FIG. 9D, base station 100 can perform a DTX detection (that is, identification of error case 2 (FIG. 9C)) on downlink allocation control information in downlink component band 1 based on whether or not PUCCH resources (PUCCH 1) of uplink component band 1 are used. This allows the base station side to optimize the coding rate or the like of downlink allocation control information while suppressing increases in signaling overhead to notify success/failure of reception of the downlink allocation control information.

Thus, according to the present embodiment, even when uplink data and response signal are simultaneously transmitted during carrier aggregation, it is possible to improve the quality of uplink data while reducing the power consumption of the terminal.

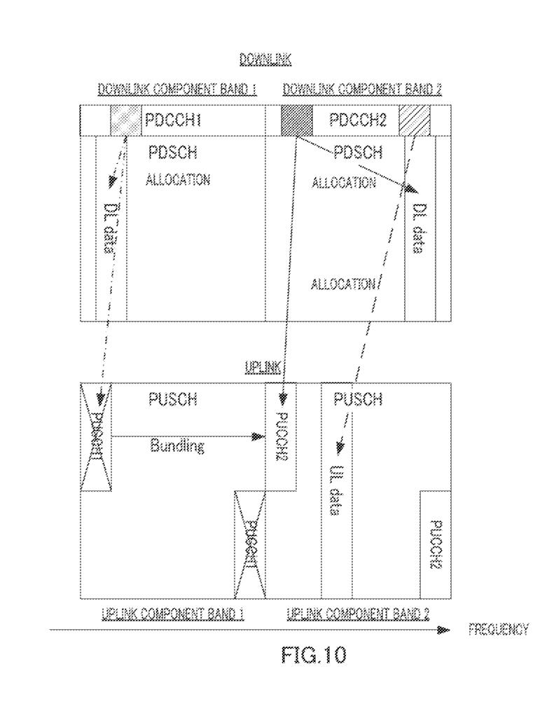

A case has been described in the present embodiment where, for example, in FIG. 4, uplink component band 1 corresponding to downlink component band 1 is preset between the base station and terminal as an uplink component band to be used to transmit a bundled ACK/NACK signal when the terminal receives downlink allocation control information using two downlink component bands 1 and 2. However, the present invention is not limited to this. For example, a case will be described where a plurality of downlink component bands 1 and 2 and a plurality of uplink component bands 1 and 2 are set as a component band group for a certain terminal. In this case, when the terminal receives uplink allocation control information corresponding to one uplink component baud, the terminal may transmit a bundled ACK/NACK signal when the terminal succeeds in receiving downlink allocation control information of both downlink component bands 1 and 2 (normal case) in the uplink component band provided with the PUSCH resources indicated by the uplink allocation control information. That is, when transmitting uplink data and response signal in the same subframe, when the terminal receives uplink allocation control information and downlink allocation control information in the first downlink component band (e.g. downlink component band 1 in FIG. 4 and downlink component band 2 in FIG. 10) of the component band group set in the terminal and receives only downlink allocation control information in a second downlink component band (e.g. downlink component band 2 in FIG. 4, downlink component baud 1 in FIG. 10), which is different from the first downlink component band, the terminal transmits one bundled ACK/NACK signal generated for a plurality of pieces of downlink data respectively transmitted in the first downlink component band and second downlink component band, using the uplink control channel associated with the downlink control channel through which the downlink allocation control information received in the first downlink component band is transmitted.

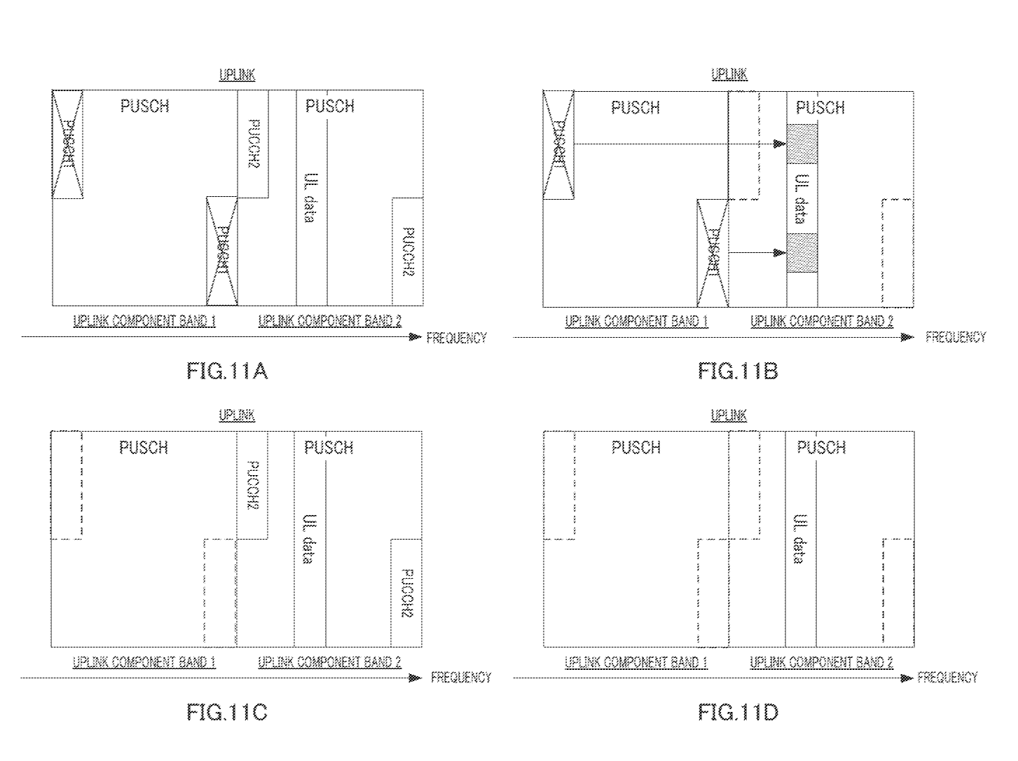

This will be described more specifically below. As shown in FIG. 4, when the base station allocates uplink data to uplink component band 1 (that is, the terminal receives uplink allocation control information in uplink component band 1), the operation of the terminal is similar to that described in FIG. 9A to FIG. 9D above. On the other hand, as shown in FIG. 10, when the base station allocates uplink data to uplink component band 2 (that is, when the terminal receives uplink allocation control information in uplink component band 2), the terminal transmits a bundled ACK/NACK signal which is logical AND of a response signal for the downlink data received in downlink component band 1 and a response signal corresponding to the downlink data received in downlink component band 2 in uplink component band 2 in which the uplink data is transmitted. To be more specific, in cases of FIG. 11A (normal case) and FIG. 11C (error case 2), that is, when the uplink component band in which uplink data is transmitted is the same (uplink component band 2) as the uplink component band in which the bundled ACK/NACK signal is transmitted, the terminal multiplexes (FDM) the uplink data and bundled ACK/NACK signal on the frequency domain. On the other hand, in a case of FIG. 11B (error case 1), that is, when the uplink component baud in which the uplink data is transmitted is different from the uplink component band in which the bundled ACK/NACK signal is transmitted, the terminal multiplexes (TDM) the uplink data and bundled ACK/NACK signal on the time domain using PUSCH resources of uplink component baud 2 in which the uplink data is transmitted. That is, as shown in FIG. 10, when uplink data is allocated to uplink component band 2, the terminal always uses only one uplink component band 2 even when uplink the data and ACK/NACK signal are transmitted in the same subframe. By this means, when the uplink data and ACK/NACK signal are transmitted at the same time, the terminal changes the uplink component band to transmit the bundled ACK/NACK signal according to the uplink component baud to transmit the uplink data, and can thereby improve the degree of freedom of scheduling of the uplink data channel (PUSCH resources) in the base station.

Furthermore, a case has been described in the present embodiment where the number of downlink component bands to which downlink data is allocated for one terminal is two. However, the present invention is also applicable even when the number of downlink component bands to which downlink data is allocated for one terminal is three or more.

Furthermore, a case has been described in the present embodiment where the terminal transmits uplink data in only one uplink component band. However, the number of uplink component bands in which uplink data is transmitted is not limited to one, but the present invention is also applicable to a case where the terminal is commanded to transmit a plurality of pieces of uplink data in two or more uplink component bands. For example, even in a case where a plurality of pieces of uplink data are transmitted in a plurality of uplink component bands, the terminal applies frequency multiplexing (FDM) to a response signal (bundled ACK/NACK signal) to be transmitted using PUCCH resources provided for the same uplink component band as the uplink component band to transmit the uplink data. On the other hand, time-multiplexing (TDM) is applied to a response signal (bundled ACK/NACK signal) to be transmitted using PUCCH resources provided for an uplink component band different from the uplink component band to transmit the uplink data.

Furthermore, a case has been described in the present embodiment where a bundling mode is applied as a transmission mode for a response signal. However, the transmission mode of the response signal is not limited to the bundling mode, but the present invention is also applicable to a case using setting in which a response signal transmitted from the terminal is always limited to one. For example, as a transmission mode for a response signal, the present invention is also applicable to a mode (channel selection or ACK/NACK multiplexing) in which one PUCCH resource is selected from a plurality of PUCCH resource groups to transmit a response signal.

### Embodiment 2

While a case has been described in Embodiment 1 where a bundling mode is applied as a transmission mode for a response signal, the present embodiment will describe a case where a non-bundling mode is applied as a transmission mode for a response signal.

Hereinafter, this will be described more specifically. Since configurations of a base station and terminal according to the present embodiment are similar to those in Embodiment 1, the configurations will be described using FIG. 7 and FIG. 8.

A communication system according to the present embodiment is different from that of Embodiment 1 in that when communication using carrier aggregation is performed, non-bundling of a response signal is adopted in ARQ.

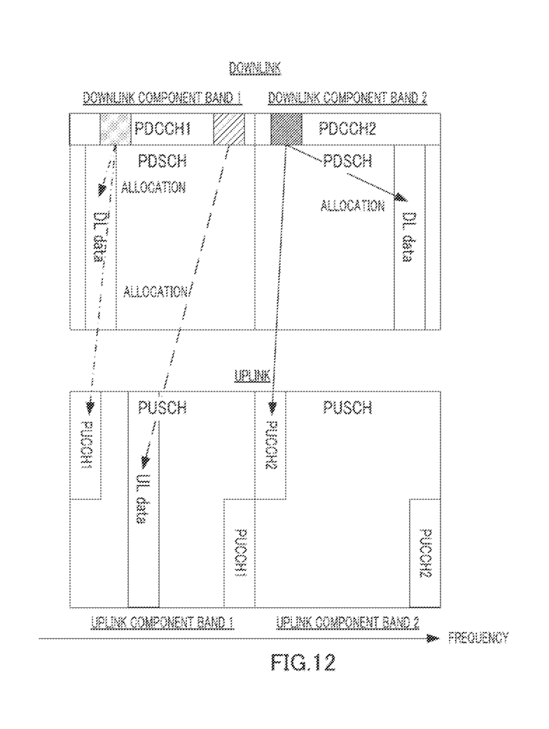

Hereinafter, operation of terminal 200 according to the present embodiment will be described. In the following descriptions, as shown in FIG. 12, a symmetric component band group comprised of two downlink component bands; downlink component bands 1 and 2 and two uplink component bands; uplink component bands 1 and 2 is set for terminal 200 as in the case of Embodiment 1 (FIG. 4). Base station 100 then transmits uplink allocation control information, downlink allocation control information and downlink data in downlink component bands 1 and 2. Here, terminal 200 normally receives uplink allocation control information included in a PDCCH signal transmitted through PDCCH 1 of the downlink component band shown in FIG. 12. That is, terminal 200 identifies an uplink data channel (PUSCH of uplink component band 1 shown in FIG. 12) used to transmit a PUSCH signal including uplink data (UL data shown in FIG. 12). Furthermore, as in the case of Embodiment 1 (FIG. 4), a plurality of CCEs making up PDCCH 1 of downlink component band 1 shown in FIG. 12 are associated with PUCCH constituent resources of uplink component band 1 and a plurality of CCEs making up PDCCH 2 of downlink component band 2 shown in FIG. 12 are associated with PUCCH constituent resources of uplink component band 2. Furthermore, terminal 200 individually transmits (that is, applies a non-bundling mode to) response signals for received downlink data in downlink component bands 1 and 2 respectively.

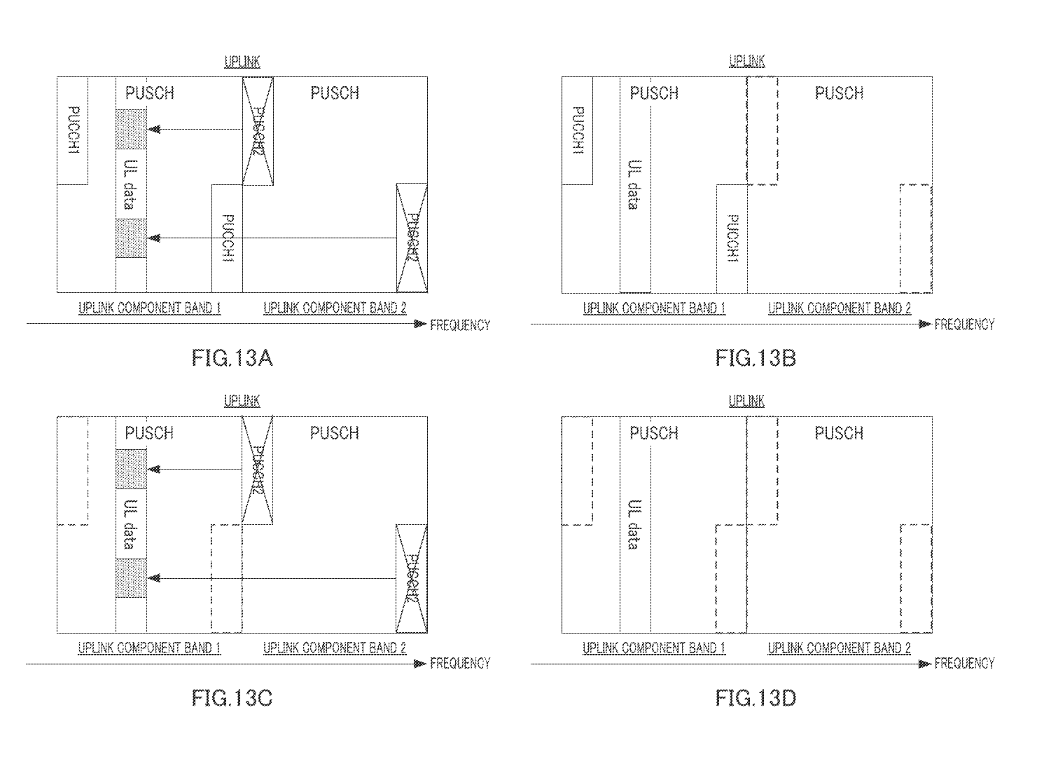

Hereinafter, detailed operation of response signal multiplexing control processing by terminal 200 according to success/failure of reception of downlink allocation control information transmitted using PDCCH 1 of downlink component band 1 and PDCCH 2 of downlink component band 2 shown in FIG. 12 will be described using FIG. 13A to FIG. 13D illustrating a normal case and error cases 1 to 3 as in the case of Embodiment 1 (FIG. 9A to FIG. 9D).

In the following descriptions, as shown in FIG. 13A to FIG. 13D, control section 208 of terminal 200 identifies PUSCH of uplink component band 1 as PUSCH resources used to transmit uplink data based on information on uplink data allocation resources corresponding to the terminal included in uplink allocation control information normally received through PDCCH 1 of downlink component band 1 shown in FIG. 12.

Furthermore, ACK/NACK control section 212 outputs each error detection result (“ACK” or “NACK”) of downlink data received in a plurality of downlink component bands 1 inputted from CRC section 211 to modulation section 214 or modulation section 217 of uplink control channel signal generation section 213 according to the command from control section 208.

<Normal Case (FIG. 13a): when Terminal 200 Receives Downlink Allocation Control Information Transmitted in Two Downlink Component Bands>

Control section 208 in terminal 200 identifies uplink component bands 1 and 2 that form a pair with downlink component bands 1 and 2 to which downlink allocation control information directed to the terminal is mapped in the component band group shown in FIG. 12 and PUCCH resources corresponding to CCEs to which downlink allocation control information is mapped.

That is, in FIG. 13A, terminal 200 identifies uplink component band 1 as an uplink component band to be used to transmit uplink data, identifies uplink component band 1 as an uplink component band to be used to transmit a response signal for downlink data received in downlink component band 1 and identifies uplink component band 2 as an uplink component band to be used to transmit a response signal for downlink data received in downlink component band 2, based on uplink allocation control information and downlink allocation control information first. That is, in FIG. 13A, when terminal 200 transmits uplink data and a response signal in the same subframe, the uplink component band to be used to transmit the uplink data is the same as the uplink component band to be used to transmit a response signal for downlink data received in downlink component band 1. On the other hand, the uplink component band to be used to transmit the uplink data is different from the uplink component band to be used to transmit a response signal for downlink data received in downlink component band 2.

Thus, control section 208 performs control so as to multiplex (FDM) the uplink data and response signal on the frequency domain and transmit the multiplexed signal in the same subframe for a response signal to transmit using the same uplink component band as the uplink component band to be used to transmit uplink data. On the other hand, control section 208 performs control so as to multiplex (TDM) the uplink data and response signal on the time domain and transmit the multiplexed signal in PUSCH resources of an uplink component band to be used to transmit uplink data for a response signal to transmit using an uplink component band different from the uplink component band to be used to transmit uplink data.

To be more specific, control section 208 commands ACK/NACK control section 212 to output a response signal for the downlink data received in downlink component band 1 shown in FIG. 12 (that is, a response signal to transmit using PUCCH resources of uplink component band 1) to modulation section 214 of uplink control channel signal generation section 213. Furthermore, control section 208 commands ACK/NACK control section 212 to output a response signal for the downlink data received in downlink component band 2 shown in FIG. 12 (that is, a response signal to transmit using PUCCH resources of uplink component band 2) to modulation section 217.

Control section 208 commands response signal/data multiplexing section 220 to time-multiplex (TDM) the uplink data and response signal (that is, a response signal to transmit using PUCCH resources of uplink component band 2). Thus, a PUSCH signal including a response signal for the downlink data received in uplink data and downlink component band 2 is inputted to PUCCH/PUSCH multiplexing section 222.

Furthermore, control section 208 commands primary-spreading section 215 and secondary-spreading section 216 of uplink control channel signal generation section 213 on a ZAC sequence and orthogonal code sequence corresponding to PUCCH resources (PUCCH 1 constituent resources) associated with CCEs occupied by downlink allocation control information received in downlink component baud 1.

Control section 208 then commands PUCCH/PUSCH multiplexing section 222 to frequency-multiplex (FDM) the PUCCH signal inputted from secondary-spreading section 216 (signal including a response signal for the downlink data received in downlink component band 1) and the PUSCH signal inputted from DFT section 221 (uplink data and a signal including a response signal for the downlink data received in downlink component band 2).

By this means, when terminal 200 transmits uplink data and a response signal in the same subframe, if terminal 200 receives uplink allocation control information and downlink allocation control information in a first downlink component band (e.g. downlink component band 1 shown in FIG. 12) of the component band group and receives only downlink allocation control information in a second downlink component band different from the first downlink component band (downlink component baud 2 in FIG. 12), terminal 200 time-multiplexes the uplink data and the response signal for the downlink data transmitted through the downlink data channel indicated by the downlink allocation control information received in the second downlink component band in the uplink data channel indicated by the uplink allocation control information received in the first downlink component band and transmits the multiplexed signal. Furthermore, terminal 200 frequency-multiplexes uplink data and a response signal for the downlink data transmitted through the downlink data channel indicated by downlink allocation control information received in the first downlink component band using the uplink control channel associated with the downlink control channel through which the downlink allocation control information received in the first downlink component band is transmitted and the uplink data channel indicated by the downlink allocation control information received in the first downlink component band and transmits the multiplexed signal.

Thus, as shown in FIG. 13A, terminal 200 transmits a PUSCH signal including uplink data and a response signal for downlink data received in downlink component band 2 using PUSCH resources of uplink component band 1 and transmits a PUCCH signal including a response signal for downlink data received in downlink component band 1 using PUCCH resources (PUCCH 1) of uplink component band 1.

That is, terminal 200 multiplexes (FDM) a response signal for the downlink data received in downlink component band 1 (a response signal in which the uplink component band to be transmitted is the same as the uplink component band in which uplink data is to be transmitted) and uplink data on the frequency domain in the same subframe using PUCCH 1 of uplink component band 1 and PUSCH of plink component band 1 and transmits the multiplexed signal. On the other hand, terminal 200 multiplexes (TDM) a response signal for the downlink data received in downlink component band 2 (a response signal for which the uplink component band to be transmitted is different from the uplink component band to transmit uplink data) and uplink data on the time domain in the same subframe using PUSCH of uplink component band 1 and transmits the multiplexed signal. Thus, terminal 200 can transmit uplink data and a plurality of response signals in a non-bundling mode in the same subframe using only one uplink component band 1.

As shown in FIG. 13A, although two response signals are transmitted in terminal 200, it is only one response signal that punctures uplink data (response signal for the downlink data received in downlink component band 2). In other words, in terminal 200, the uplink data is not punctured by a response signal to be transmitted in the same uplink component band as the uplink component band to transmit uplink data of a plurality of response signals. Thus, terminal 200 can suppress quality deterioration of uplink data by puncturing to a minimum.

By this means, terminal 200 can transmit uplink data and a plurality of response signals in the same subframe using only one uplink component band (uplink component band 1 in FIG. 13A) while suppressing puncturing of the uplink data to a minimum.

<Error Case 1 (FIG. 13b): when Terminal 200 Receives Only Downlink Allocation Control Information Transmitted in Downlink Component Band 1>

In terminal 200, control section 208 identifies uplink component band 1 that forms a pair with downlink component band 1 to which downlink allocation control information directed to the terminal is mapped in the component band group shown in FIG. 12 and PUCCH resources corresponding to CCEs to which downlink allocation control information is mapped.

That is, in FIG. 13B, terminal 200 identifies uplink component band 1 as an uplink component band to be used to transmit uplink data and identifies uplink component band 1 as an uplink component band to be used to transmit a response signal for downlink data received in downlink component band 1 based on uplink allocation control information and downlink allocation control information first. That is, in FIG. 13B, when terminal 200 transmits the uplink data and response signal in the same subframe, the uplink component band to be used to transmit uplink data is the same (uplink component band 1) as the uplink component band to be used to transmit a response signal.

Thus, control section 208 performs control so as to multiplex (FDM) a PUSCH signal including uplink data and a PUCCH signal including a response signal for downlink data received in downlink component band 1 on the frequency domain and transmit the multiplexed signal in the same subframe as in error case 1 (FIG. 9B) of Embodiment 1.

To be more specific, control section 208 commands ACK/NACK control section 212 to output a response signal for the downlink data received in downlink component band 1 shown in FIG. 12 to modulation section 214 of uplink control channel signal generation section 213. Furthermore, control section 208 commands response signal/data multiplexing section 220 not to time-multiplex (TDM) the uplink data and response signal and commands PUCCH/PUSCH multiplexing section 222 to frequency-multiplex (FDM) the PUCCH signal inputted from secondary-spreading section 216 (signal including a response signal) and the PUSCH signal inputted from DFT section 221 (signal including uplink data).

Furthermore, control section 208 commands primary-spreading section 215 and secondary-spreading section 216 of uplink control channel signal generation section 213 on a ZAC sequence and orthogonal code sequence corresponding to PUCCH resources (PUCCH 1 constituent resources) associated with CCEs occupied by downlink allocation control information received in downlink component band 1.

Thus, as shown in FIG. 13B, terminal 200 transmits the PUSCH signal including uplink data using the PUSCH resources of uplink component band 1 and transmits the PUCCH signal including a response signal for downlink data received in downlink component band 1 using the PUCCH resources (PUCCH 1) of uplink component band 1. That is, terminal 200 multiplexes (FDM) the uplink data and response signal using PUCCH 1 of uplink component band 1 and PUSCH of the uplink component band on the frequency domain and transmits the multiplexed signal in the same subframe as in error case 1 (FIG. 9B) of Embodiment 1.

Thus, terminal 200 can transmit the uplink data and response signal in the same subframe using only one uplink component band (uplink component band 1 in FIG. 13B) without puncturing the uplink data.

The operation of terminal 200 shown in FIG. 13B is applicable not only to error case 1 (when failing to receive downlink allocation control information of downlink component band 2 in FIG. 13B) but also to a case where base station 100 transmits downlink allocation control information to terminal 200 using only downlink component band 1. That is, terminal 200 determines the method of multiplexing uplink data and ACK/NACK signal (here, time-multiplexing (TDM) or frequency-multiplexing (FDM)) according to the number of pieces of downlink allocation control information actually received by the terminal and the position of the downlink component band to which the received downlink allocation control information is mapped irrespective of the number of downlink component bands used for base station 100 to actually transmit downlink allocation control information.

<Error Case 2 (FIG. 13c): when Terminal 200 Receives Only Downlink Allocation Control Information Transmitted in Downlink Component Band 2>

In terminal 200, control section 208 identifies uplink component band 2 that forms a pair with downlink component band 2 to which downlink allocation control information directed to the terminal is mapped of the component band group shown in FIG. 12, and PUCCH resources corresponding to CCEs to which downlink allocation control information is mapped.

That is, in FIG. 13C, terminal 200 identifies uplink component band 1 as an uplink component band to be used to transmit uplink data and identifies uplink component baud 2 as an uplink component band to be used to transmit a response signal for downlink data received in downlink component band 2 based on uplink allocation control information and downlink allocation control information first. That is, in FIG. 13C, when terminal 200 transmits the uplink data and response signal in the same subframe, the uplink component band (uplink component band 1) to be used to transmit uplink data is different from the uplink component band (uplink component band 2) to be used to transmit a response signal for downlink data received in downlink component baud 2.

Thus, control section 208 performs control so as to multiplex (TDM) the uplink data and response signal on the time domain using PUSCH resources of the uplink component band to be used to transmit uplink data and transmit the multiplexed signal.

To be more specific, control section 208 commands ACK/NACK control section 212 to output a response signal for the downlink data received in downlink component band 2 shown in FIG. 12 to modulation section 217. Furthermore, control section 208 commands response signal/data multiplexing section 220 to time-multiplex (TDM) the uplink data and response signal. Thus, response signal/data multiplexing section 220 punctures the uplink data by the response signal, and thereby time-multiplexes the uplink data and response signal. Thus, a PUSCH signal including the uplink data and response signal is inputted to PUCCH/PUSCH multiplexing section 222.

Furthermore, control section 208 commands PUCCH/PUSCH multiplexing section 222 to perform IFFT processing on only a PUSCH signal (signal including the uplink data and response signal) inputted from DFT section 221.

Thus, as shown in FIG. 13C, terminal 200 transmits the PUSCH signal including the uplink data and response signal for the downlink data received in downlink component band 2 using PUSCH resources of uplink component band 1. That is, terminal 200 multiplexes (TDM) the uplink data and response signal on the time domain and transmits the multiplexed signal in the same subframe through PUSCH of uplink component band 1 without using PUCCH 2 of uplink component band 2.

Thus, terminal 200 can transmit the uplink data and response signal in the same subframe using only one uplink component band (uplink component band 1 in FIG. 13C).

Here; in FIG. 13C, the uplink data mapped to the PUSCH resources of uplink component band 1 is punctured by a response signal, and therefore the quality of uplink data deteriorates. However, since an LTE-A system is operated with an error rate of downlink allocation control information (that is, target BLER of PDCCH) of on the order of 1%, the possibility that error case 2 (FIG. 13C) may occur is extremely small (frequency with which error case 2 occurs: on the order of 1%). Even when terminal 200 time-multiplexes the uplink data and response signal (that is, the uplink data is punctured), the influence on the entire system is extremely small only in error case 2 shown in FIG. 13C as in the case of Embodiment 1 (FIG. 9C).

The operation of terminal 200 shown in FIG. 13C is applicable not only to error case 2 (when failing to receive downlink allocation control information of downlink component band 1 in FIG. 13C) but also to a case where base station 100 transmits downlink allocation control information to terminal 200 using only downlink component band 2. For example, base station 100 may allocate downlink data (that is, downlink allocation control information) to only downlink component band 2 and allocate uplink data (that is, uplink allocation control information) to only uplink component band 1. However, in this case, even when terminal 200 normally receives all allocation information (uplink allocation control information transmitted in downlink component baud 1 and downlink allocation control information transmitted in downlink component band 2), that is, in a normal case, the uplink data transmitted in the uplink component band is punctured by a response signal for the downlink data transmitted in downlink component band 2 as shown in FIG. 13C. Therefore, base station 100 generally does not perform such an operation as to allocate downlink data only to one downlink component band (downlink component band 2 in FIG. 13C) for terminal 200 and at the same time allocate uplink data only to the other uplink component band (uplink component band 1 in FIG. 13C).

<Error Case 3 (FIG. 13d): when Terminal 200 Receives None of Downlink Allocation Control Information Transmitted in Downlink Component Bands 1 and 2>

In error case 3 shown in FIG. 13D, terminal 200 does not know the presence of downlink allocation control information transmitted by base station 100 in downlink component bands 1 and 2, and cannot thereby receive downlink data, and therefore there is no ACK/NACK signal to transmit. Thus, terminal 200 identifies uplink component band 1 as an uplink component band to be used to transmit uplink data based on uplink allocation control information as shown in FIG. 13D as in the case of Embodiment 1 (FIG. 9D).

Thus, control section 208 commands response signal/data multiplexing section 220 not to time-multiplex (TDM) the uplink data and response signal. Furthermore, control section 208 commands PUCCH/PUSCH multiplexing section 222 to perform IFFT processing on only a PUSCH signal (signal including the uplink data signal) inputted from DFT section 221.

In this way, as shown in FIG. 13D, terminal 200 transmits a PUSCH signal including the uplink data using PUSCH resources of uplink component band 1.

The operation of terminal 200 according to success/failure of reception of a PDCCH signal including downlink allocation control information has been described so far.

On the other hand, in FIG. 12 as in the case of Embodiment 1, decision section 122 of base station 100 decides whether or not the response signal for downlink data transmitted in PDSCH resources indicated by each piece of downlink allocation control information of downlink component bands 1 and 2 is included in PUCCH resources (PUCCH 1 constituent resources and 2) of uplink component bands 1 and 2 corresponding to downlink component bands 1 and 2 used to transmit downlink allocation control information or PUSCH resources indicated by uplink allocation control information of downlink component band 1.

For example, in FIG. 13A, decision section 122 of base station 100 decides that a response signal for downlink data transmitted in downlink component band 1 is included in PUCCH 1 of uplink component band 1 provided with PUSCH resources indicated by uplink allocation control information transmitted in downlink component band 1. Furthermore, in FIG. 13A, decision section 122 decides that a response signal for downlink data transmitted in downlink component band 2 is included in PUSCH resources indicated by uplink allocation control information transmitted in downlink component baud 1.

Furthermore, in FIG. 13B, decision section 122 of base station 100 decides that a response signal for downlink data transmitted in downlink component band 1 is included in PUCCH 1 of uplink component band 1 provided with PUSCH resources indicated by uplink allocation control information transmitted in downlink component band 1. On the other hand, in FIG. 13C, decision section 122 of base station 100 decides that a response signal for downlink data transmitted in downlink component band 2 is included in PUSCH resources indicated by uplink allocation control information transmitted in downlink component band 1.

That is, when receiving uplink data and a response signal in the same subframe, decision section 122 of base station 100 receives both the uplink data and each response signal for downlink data transmitted in a plurality of downlink component bands in the same uplink component band (uplink component band 1 in FIG. 13A to FIG. 13C) as in the case of Embodiment 1.

By this means, terminal 200 determines whether to time-multiplex or frequency-multiplex the uplink data and each response signal depending on whether or not the uplink component baud to transmit each response signal for downlink data transmitted in a plurality of downlink component bands is the same as the uplink component band to transmit the uplink data.

Thus, even when a plurality of response signals are transmitted (e.g. normal case (FIG. 13A)), terminal 200 can reduce the frequency with which uplink data is punctured by a response signal. Furthermore, the probability (target BLER of PDCCH) that error case 2 shown in FIG. 13C may occur is on the order of 1% as described above as in the case of Embodiment 1. Therefore, as shown in FIG. 13A to FIG. 13D, the present embodiment uses time-multiplexing (TDM) for only some response signals in a normal case (FIG. 13A) and in error case 2 (FIG. 13C). Thus, the use of time-multiplexing (TDM) can be suppressed to a minimum. This allows terminal 200 to substantially suppress quality deterioration of uplink data.

Furthermore, as shown in FIG. 13A to FIG. 13C, when transmitting uplink data and a plurality of response signals in the same subframe, terminal 200 always use only one uplink component band (uplink component band 1 in FIG. 13A to FIG. 13C). That is, even when transmitting uplink data and response signal in the same subframe, terminal 200 can reduce the bands used for the uplink to minimum necessary uplink component bands to transmit uplink data (PUSCH signal). This allows terminal 200 to reduce power consumption upon transmission of uplink data and a response signal as in the case of Embodiment 1.

Furthermore, as shown in FIG. 13A to FIG. 13D, base station 100 can perform a DTX detection (that is, identifies error case 2 (FIG. 13C)) on downlink allocation control information in downlink component band 1 based on whether or not PUCCH resources (PUCCH 1 constituent resources) in uplink component band 1 are used. This allows the base station side to optimize a coding rate or the like of downlink allocation control information while suppressing increases of signaling overhead for notifying success/failure of reception of downlink allocation control information.

Thus, according to the present embodiment, when a non-bundling mode is applied as a transmission mode for a response signal, it is possible to improve the quality of uplink data while reducing the power consumption of the terminal even when uplink data and a response signal are simultaneously transmitted during carrier aggregation.

A case has been described in the present embodiment where the number of downlink component bands to which downlink data is allocated for one terminal is two. However, the present invention is also applicable to a case where the number of downlink component bands to which downlink data is allocated for one terminal is three or more and a non-bundling mode is applied as a transmission mode for a response signal. Furthermore, when there are three or more downlink component bands, the terminal may bundle a plurality of response signals time-multiplexed with uplink data (that is, response signals to be transmitted in an uplink component band different from the uplink component band to transmit uplink data) and puncture the uplink data by the bundled response signal (bundled ACK/NACK signal) to reduce the frequency of puncturing of uplink data by a response signal.

Furthermore, a case has been described in the present embodiment where the terminal transmits uplink data using only one uplink component band. However, the number of uplink component bands to transmit uplink data is not limited to one, but the present invention is also applicable to a case where the terminal is commanded to transmit a plurality of pieces of uplink data in two or more uplink component bands. For example, even when a plurality of pieces of uplink data are transmitted in a plurality of uplink component bands, the terminal applies frequency-multiplexing (FDM) to a response signal to be transmitted using PUCCH resources provided for the same uplink component band as the uplink component baud to transmit the uplink data. On the other hand, the terminal applies time-multiplexing (TDM) to a response signal to be transmitted using PUCCH resources provided for an uplink component band different from the uplink component baud to transmit the uplink data.

Embodiments of the present invention have been described so far.

A case has been described in the above-described embodiments where uplink data and a response signal are multiplexed. However, signals multiplexed are not limited to a response signal, but the present invention is also applicable to a case where uplink data and other uplink control signals are multiplexed. To be more specific, examples of uplink control signals other than response signals include CQI (Channel Quality Indicator) indicating quality of a downlink propagation path between the base station and terminal and SR (Scheduling Request) for the terminal to request the base station to allocate uplink resources when the terminal side needs to transmit new uplink data.

Furthermore, a case has been described in the above-described embodiments where a ZAC sequence is used for primary-spreading of PUCCH resources and an orthogonal code sequence is used for secondary-spreading. However, the present invention may also use non-ZAC sequences which are mutually separable by different amounts of cyclic shift for primary-spreading. For example, GCL (Generalized Chirp like) sequence, CAZAC (Constant Amplitude Zero Auto Correlation) sequence, ZC (Zadoff-Chu) sequence, M sequence, PN sequence such as orthogonal gold code sequence or a sequence randomly generated by a computer and having an abrupt auto-correlation characteristic on the time domain or the like may be used for primary-spreading. Furthermore, sequences orthogonal to each other or any sequences may be used as orthogonal code sequences for secondary-spreading as long as they are regarded as sequences substantially orthogonal to each other. In the above descriptions, resources (e.g. PUCCH resources) of response signals are defined by the amount of cyclic shift of a ZAC sequence and a sequence number of an orthogonal code sequence.

Furthermore, the ZAC sequence according to the above-described embodiments may also be called a “base sequence” in the sense that it is a sequence that becomes the basis for applying cyclic shift processing.

A case has been described in the above-described embodiments where IFFT transform is performed after primary-spreading and secondary-spreading as the order of processing on the terminal side. However, the order of processing is not limited to this. That is, since both primary-spreading and secondary-spreading are multiplication processing, an equivalent result may be obtained regardless of the location of secondary-spreading processing as long as IFFT processing follows primary-spreading processing.

Furthermore, since the spreading section (primary-spreading section, secondary-spreading section) according to the above-described embodiments performs processing of multiplying a certain signal by a sequence, the spreading section may also be called a “multiplication section.”

Moreover, although cases have been described with the embodiments above where the present invention is configured by hardware, the present invention may be implemented by software.

Each function block employed in the description of the aforementioned embodiment may typically be implemented as an LSI constituted by an integrated circuit. These may be individual chips or partially or totally contained on a single chip. “LSI” is adopted here but this may also be referred to as “IC,” “system LSI,” “super LSI” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2009-138610, filed on Jun. 9, 2009, including the specification, drawings and abstract, is incorporated herein by reference in its entirety.

### INDUSTRIAL APPLICABILITY

The present invention is applicable to a mobile communication system or the like.

### REFERENCE SIGNS LIST

100 Base station
200 Terminal
101, 208 Control section
102 Control information generation section
103, 105 Coding section
104, 107, 214, 217 Modulation section
106 Data transmission control section
108 Mapping section
109 IFFT section
110, 223 CP adding section
111, 224 Radio transmitting section
112, 201 Radio receiving section
113, 202 CP removing section
114 PUCCH/PUSCH demultiplexing section
115, 120 Despreading section
116 Sequence control section
117 Correlation processing section
118 IDFT section
119 Response signal demultiplexing section
121 Demodulation/decoding section
122, 207 Decision section
123 Retransmission control signal generation section
203 FFT section
204 Extraction section
205, 209 Demodulation section
206,210 Decoding section
211 CRC section
212 ACK/NACK control section
213 Uplink control channel signal generation section
215 Primary-spreading section
216 Secondary-spreading section
218 Spreading section
219 Coding/modulation section
220 Multiplexing section
221 DFT section
222 PUCCH/PUSCH multiplexing section

1. A terminal apparatus that communicates with a base station apparatus using a component band group comprised of N (where N is a natural number equal to 2 or above) downlink component bands and uplink component bands, and transmits a response signal based on an error detection result of downlink data arranged in a downlink component band through an uplink control channel in an uplink component band corresponding to the downlink component band, the terminal apparatus comprising:
a control information receiving section that receives uplink allocation control information and downlink allocation control information transmitted through downlink control channels of the N downlink component bands;
a downlink data receiving section that receives downlink data transmitted through a downlink data channel indicated by the downlink allocation control information;
an uplink data transmission section that transmits uplink data through an uplink data channel indicated by the uplink allocation control information; and
a control section that controls transmission of the response signal based on the uplink allocation control information and the downlink allocation control information, wherein:
the control section receives, when transmitting the uplink data and the response signal within the same transmission unit time, only the uplink allocation control information in a first downlink component band of the component band group, and time-multiplexes, when receiving only the downlink allocation control information in a second downlink component band different from the first downlink component band, the uplink data and the response signal for the downlink data transmitted through the downlink data channel indicated by the downlink allocation control information received in the second downlink component band, in the uplink data channel indicated by the uplink allocation control information received in the first downlink component baud, and transmits the time-multiplexed signal.

2. The terminal apparatus according to claim 1, wherein, when transmitting the uplink data and the response signal in the same transmission unit time, if the uplink allocation control information and the downlink allocation control information are received in the first downlink component band of the component band group and only the downlink allocation control information is received in the second downlink component band of the component band group, the control section transmits one bundled response signal generated for a plurality of pieces of the downlink data transmitted in the first downlink component baud and the second downlink component band is transmitted, using an uplink control channel associated with the downlink control channel in which the downlink allocation control information received in the first downlink component band.

3. The terminal apparatus according to claim 1 wherein, when transmitting the uplink data and the response signal in the same transmission unit time, if the uplink allocation control information and the downlink allocation control information are received in the first downlink component band of the component band group and only the downlink allocation control information is received in the second downlink component band of the component band group, the control section time-multiplexes the uplink data and the response signal for the downlink data transmitted through the downlink data channel indicated by the downlink allocation control information received in the second downlink component band, in the uplink data channel indicated by the uplink allocation control information received in the first downlink component baud and transmits the time-multiplexed signal, and frequency-multiplexes the uplink data and the response signal for the downlink data transmitted through the downlink data channel indicated by the downlink allocation control information received in the first downlink component band using an uplink control channel associated with the downlink control channel in which the downlink allocation control information received in the first downlink component band is transmitted and the uplink data channel indicated by the downlink allocation control information received in the first downlink component band and transmits the frequency-multiplexed signal.

4. A signal multiplexing control method comprising:
a control information receiving step of receiving uplink allocation control information and downlink allocation control information transmitted in downlink control channels of N (where N is a natural number equal to 2 or above) downlink component bands included in a component band group;
a downlink data receiving step of receiving downlink data transmitted in a downlink data channel indicated by the downlink allocation control information;
an uplink data transmitting step of transmitting uplink data through an uplink data channel indicated by the uplink allocation control information; and
a control step of controlling transmission of the response signal based on the uplink allocation control information and the downlink allocation control information, wherein:
in the control step, when the uplink data and the response signal are transmitted in the same transmission unit time, if only the uplink allocation control information is received in a first downlink component band of the component band group and only the downlink allocation control information is received in a second downlink component band different from the first downlink component band, the uplink data and the response signal for the downlink data transmitted through the downlink data channel indicated by the downlink allocation control information received in the second downlink component band are time-multiplexed and transmitted in the uplink data channel indicated by the uplink allocation control information received in the first downlink component band.
